(19) United States
(12) Patent Application Publication
(10) Pub. No.: US 2026/0136335 A1
(43) Pub. Date: May 14, 2026

(54) SYSTEMS AND METHODS FOR DECENTRALIZED GROUP AUDIO COMMUNICATION

(71) Applicant: Meta Platforms Technologies, LLC, Menlo Park, CA (US)

(72) Inventors: Kanji Mavji KERAI, London (GB); Guoqing LI, Cupertino, CA (US); Sam PADINJAREMANNIL ALEX, Dublin, CA (US)

(73) Assignee: Meta Platforms Technologies, LLC, Menlo Park, CA (US)

(21) Appl. No.: 19/358,625

(22) Filed: Oct. 15, 2025

Related U.S. Application Data
(60) Provisional application No. 63/718,882, filed on Nov. 11, 2024.

(51) Int. Cl. H04W 72/0446; G06F 3/16; G10L 25/78; H04W 4/06; H04W 72/30

(52) U.S. Cl. CPC H04W 72/0446; G06F 3/162; G10L 25/78; H04W 4/06; H04W 72/30

(57) ABSTRACT

Systems and methods for decentralized group audio communication may include a secondary device which receives a first periodic signal broadcast from a primary device, which information for participation in a group communication session. The secondary device may detect a signal from an on-device sensor indicative of speech input at the secondary device, transmit a slot allocation request to the primary device in response to detecting the signal indicative of speech input, receive a second periodic signal assigning a communication slot to the secondary device for broadcasting information to the device group, and broadcast, during the assigned communication slot, audio signals representative of speech captured at the secondary device, for receipt by other devices within the device group.

### CROSS-REFERENCE TO RELATED APPLICATIONS

The present application claims the benefit of and priority to U.S. Provisional Patent Application No. 63/718,882 , filed Nov. 11, 2024, the contents of which is incorporated herein by reference in its entirety.

### FIELD OF DISCLOSURE

This disclosure is directed to wireless communication systems, including but not limited to systems and methods for decentralized group audio communication.

### BACKGROUND

Wireless communication systems facilitate devices to exchange information using radio frequency signals across various network topologies. Audio data can be transmitted among multiple devices for applications such as conferencing, streaming, or real-time collaboration.

### SUMMARY

At least one aspect relates to a primary device. The primary device can include one or more processors. The one or more processors can receive a request to establish a group communication session of a device group, including the primary device. The one or more processors can broadcast, via a wireless transceiver, a first periodic signal for receipt by any secondary devices within wireless communication range, the first periodic signal including information for participation in the group communication session. The one or more processors can receive, from one or more secondary devices which received an instance of the periodic synchronization signal, signaling indicating an intent to participate in the device group. The one or more processors can assign communication resources to respective members of the device group, the communication resources including one or more slots for broadcasting of information to the device group. The one or more processors can broadcast, via the wireless transceiver, a second periodic signal for devices in the device group, the second periodic signal indicating the assigned communication resources.

In some implementations, the first periodic signal further comprises a session identifier corresponding to the group communication session, and a timestamp for clock alignment among the device group. In some implementations, the communication resources assigned to the respective members of the device group in the second periodic signal are based on detected voice activity on a respective device of the device group. In some implementations, the communication resources are assigned to a subset of the device group, up to a maximum number of devices, based on the detected voice activity on the subset and corresponding signaling received by the primary device from the subset. In some implementations, the one or more processors can determine a lapse in receipt of a status signal from a respective device in the device group for a predetermined duration, the respective device having a role as a backup primary device. In some implementations, the one or more processors can update the second periodic signal to indicate removal of the respective device from the role as the backup primary device.

In some implementations, the one or more processors can select, from the one or more secondary devices, a first device to designate as a backup primary device. In some implementations, the one or more processors can update the second periodic signal to include information identifying the backup primary device to the device group. In some implementations, the one or more processors can transmit, via the wireless transceiver, to the backup primary device, clock information for synchronization between the primary device and the backup primary device. In some implementations, the one or more processors can monitor confirmation messages from the backup primary device.

In some implementations, the one or more processors can determine, based on an absence of the confirmation messages or status messages from the backup primary device, a loss of connectivity with the backup primary device. In some implementations, the one or more processors can select, responsive to determining the loss of connectivity, a second device from the one or more secondary devices which remain in the device group, to designate as the backup primary device. In some implementations, the one or more processors can update the information included in the second periodic signal, to include information identifying the second device as the backup primary device to the device group.

In some implementations, the one or more processors can receive, from a device requesting to participate in the device group, onboarding information comprising at least one of a machine-readable code, a uniform resource locator (URL), a voice-derived identifier, or user input via selectable elements on the device. In some implementations, the one or more processors can transmit, to the device, session participation information via the periodic synchronization signal. In some implementations, the device comprises a listen-only device.

At least one other aspect relates to a method. The method can be performed, for example, by one or more processors coupled to non-transitory memory. The method can include receiving a request to establish a group communication session of a device group, including the primary device. The method can include periodically broadcasting, via a wireless transceiver, a first periodic signal for receipt by any secondary devices within wireless communication range, the first periodic signal including information for participation in the group communication session. The method can include receiving, from one or more secondary devices which received an instance of the synchronization signal, signaling indicating an intent to participate in the device group. The method can include assigning communication resources to respective members of the device group, the communication resources including one or more slots for broadcasting of information to the device group. The method can include broadcasting, via the wireless transceiver, a second periodic signal for devices in the device group, the second periodic signal indicating the assigned communication resources.

In some implementations, the method can include incorporating a session identifier and a timestamp in the first periodic signal, the session identifier corresponding to the group communication session and the timestamp for clock alignment among the device group. In some implementations, assigning communication resources to respective members of the device group comprises assigning the communication resources based on detected voice activity on a device of the device group. In some implementations, assigning the communication resources comprises assigning the communication resources to a subset of the device group, up to a maximum number of devices, based on the detected voice activity on the subset and corresponding signaling received by the primary device from the subset.

In some implementations, the method can include determining a lapse in receipt of a status signal from a respective device in the device group for a predetermined duration, the respective device having a role as a backup primary device. In some implementations, the method can include updating the second periodic signal to indicate removal of the respective device from the role as the backup primary device. In some implementations, the method can include selecting, from the one or more secondary devices, a first device to designate as a backup primary device. In some implementations, the method can include updating the second periodic signal to include information identifying the backup primary device to the device group.

In some implementations, the method can include transmitting, via the wireless transceiver, to the backup primary device, clock information for synchronization between the primary device and the backup primary device. In some implementations, the method can include monitoring confirmation messages from the backup primary device. In some implementations, the method can include determining, based on an absence of the confirmation messages or status messages from the backup primary device, a loss of connectivity with the backup primary device. In some implementations, the method can include selecting, responsive to determining the loss of connectivity, a second device from among the secondary devices remaining in the device group to designate as the backup primary device. In some implementations, the method can include updating the information included in the second periodic signal to include information identifying the second device as the backup primary device to the device group.

In some implementations, the method can include receiving, from a device requesting to participate in the device group, onboarding information comprising at least one of a machine-readable code, a uniform resource locator (URL), a voice-derived identifier, or a user input via selectable elements on the device. In some implementations, the method can include transmitting, to the device, session participation information via the periodic synchronization signal.

At least one aspect relates to a non-transitory computer readable medium. The non-transitory computer readable medium can store instructions that, when executed by one or more processors of a primary device, cause the one or more processors to receive a request to establish a group communication session of a device group, including the primary device. The instructions can cause the one or more processors to broadcast, via a wireless transceiver, a first periodic signal for receipt by any secondary devices within wireless communication range, the first periodic signal including information for participation in the group communication session. The instructions can cause the one or more processors to receive, from one or more secondary devices which received an instance of the periodic synchronization signal, signaling indicating an intent to participate in the device group. The instructions can cause the one or more processors to assign communication resources to respective members of the device group, the communication resources including one or more slots for broadcasting of information to the device group. The instructions can cause the one or more processors to broadcast, via a wireless transceiver, a second periodic signal for devices in the device group, the second periodic signal indicating the assigned communication resources.

At least one aspect relates to a secondary device. The secondary device can include one or more processors. The one or more processors can receive, via a wireless transceiver, a first periodic signal broadcast from a primary device, the first periodic signal including information for participation in a group communication session. The one or more processors can detect a signal from an on-device sensor indicative of speech input at the secondary device. The one or more processors can transmit, via the wireless transceiver, a slot allocation request to the primary device in response to detecting the signal indicative of speech input. The one or more processors can receive, via the wireless transceiver, a second periodic signal broadcast from the primary device, the second periodic signal assigning a communication slot to the secondary device for broadcasting information to the device group. The one or more processors can broadcast, via the wireless transceiver and during the assigned communication slot, audio signals representative of speech captured at the secondary device, for receipt by other devices within the device group.

In some implementations, the request includes device identification information and authentication information. In some implementations, the one or more processors can receive, via the wireless transceiver, an indication that the secondary device is designated as a backup primary device for the group communication session. In some implementations, the indication is received in the second periodic signal. In some implementations, the one or more processors can receive, via the wireless transceiver, from the primary device, clock information for synchronization between the primary device and the backup primary device. In some implementations, the one or more processors can transmit, via the wireless transceiver, a confirmation message to the primary device. In some implementations, the one or more processors can synchronize one or more clocks of the secondary device according to the clock information received from the primary device.

In some implementations, the one or more processors can determine, based on a lapse in receipt of periodic signals or other status information from the primary device, that the primary device is offline or unavailable. In some implementations, the one or more processors can assume the role of primary device for the device group in response to determining that the primary device is offline or unavailable. In some implementations, the one or more processors can broadcast, via the wireless transceiver and responsive to assuming the role of the primary device, a new first periodic signal and a new second periodic signal to the device group, the new second periodic signal indicating that the secondary device is now the primary device.

In some implementations, the one or more processors can assign communication resources to respective members of the device group, the communication resources including one or more slots for broadcasting of information to the device group, and wherein the assigned communication resources is indicated in the new second periodic signal.

In some implementations, the signal and the slot allocation request correspond to a first time instance. In some implementations, the one or more processors can detect, at a second time instance, a second signal from an on-device sensor indicative of subsequent speech input at the secondary device. In some implementations, the one or more processors can determine, based on a most recent second periodic signal from the primary device, an allocation of each of a maximum number of communication resource to a respective device of the device group. In some implementations, the one or more processors can forego transmission of a slot allocation request to the primary device, based on a lack of availability of communication resources.

At least one other aspect relates to a method. The method can be performed, for example, by one or more processors coupled to non-transitory memory. The method can include receiving, via a wireless transceiver of a secondary device, a first periodic signal broadcast from a primary device, the first periodic signal including information for participation in a group communication session. The method can include detecting a signal from an on-device sensor indicative of speech input at the secondary device. The method can include transmitting, via the wireless transceiver, a slot allocation request to the primary device in response to detecting the signal indicative of speech input. The method can include receiving, via the wireless transceiver, a second periodic signal broadcast from the primary device, the second periodic signal assigning a communication slot to the secondary device for broadcasting information to the device group. The method can include broadcasting, via the wireless transceiver and during the assigned communication slot, audio signals representative of speech captured at the secondary device, for receipt by other devices within the device group.

In some implementations, the method can include receiving, via the wireless transceiver, an indication that the secondary device is designated as a backup primary device for the group communication session. In some implementations, the indication is received in the second periodic signal. In some implementations, the method can include receiving, via the wireless transceiver, from the primary device, clock information for synchronization between the primary device and the backup primary device. In some implementations, the method can include transmitting, via the wireless transceiver, a confirmation message to the primary device. In some implementations, the method can include synchronizing one or more clocks of the secondary device according to the clock information received from the primary device.

In some implementations, the method can include determining, based on a lapse in receipt of periodic signals or other status information from the primary device, that the primary device is offline or unavailable. In some implementations, the method can include assuming the role of primary device for the device group in response to determining that the primary device is offline or unavailable. In some implementations, the method can include broadcasting, via the wireless transceiver and responsive to assuming the role of the primary device, a new first periodic signal and a new second periodic signal to the device group, the new second periodic signal indicating that the secondary device is now the primary device. In some implementations, the method can include assigning communication resources to respective members of the device group, the communication resources including one or more slots for broadcasting of information to the device group, and wherein the assigned communication resources is indicated in the new second periodic signal.

In some implementations, the signal and the slot allocation request correspond to a first time instance. In some implementations, the method can include detecting, at a second time instance, a second signal from an on-device sensor indicative of subsequent speech input at the secondary device. In some implementations, the method can include determining, based on a most recent second periodic signal from the primary device, an allocation of each of a maximum number of communication resource to a respective device of the device group. In some implementations, the method can include foregoing transmission of a slot allocation request to the primary device, based on a lack of availability of communication resources.

At least one other aspect relates to a non-transitory computer readable medium. The non-transitory computer readable medium can store instructions that, when executed by one or more processors of a secondary device, cause the one or more processors to receive, via a wireless transceiver, a first periodic signal broadcast from a primary device, the first periodic signal including information for participation in a group communication session. The instructions can cause the one or more processors to detect a signal from an on-device sensor indicative of speech input at the secondary device. The instructions can cause the one or more processors to transmit, via the wireless transceiver, a slot allocation request to the primary device in response to detecting the signal indicative of speech input. The instructions can cause the one or more processors to receive, via the wireless transceiver, a second periodic signal broadcast by the primary device, the second periodic signal assigning a communication slot to the secondary device for broadcasting information to the device group. The instructions can cause the one or more processors to broadcast, via the wireless transceiver and during the assigned communication slot, audio signals representative of speech captured at the secondary device, for receipt by other devices within the device group.

### BRIEF DESCRIPTION OF THE DRAWINGS

The accompanying drawings are not intended to be drawn to scale. Like reference numbers and designations in the various drawings indicate like elements. For purposes of clarity, not every component can be labeled in every drawing.

FIG. 1 is a diagram of a system environment including an artificial reality system, according to an example implementation of the present disclosure.

FIG. 2 is a diagram of a head wearable display, according to an example implementation of the present disclosure.

FIG. 3 is a block diagram of a computing environment according to an example implementation of the present disclosure.

FIG. 4 is a diagram of an example wireless communication system, according to an example implementation of the present disclosure.

FIG. 5 illustrates a schematic diagram of a system showing a device group in a decentralized session, according to an example implementation of the present disclosure.

FIG. 6 illustrates a diagram depicting hierarchical ranking for clock synchronization among a device group, according to an example implementation of the present disclosure.

FIG. 7 depicts an example timing sequence illustrating slot allocation and synchronization updates among devices, according to an example implementation of the present disclosure.

FIG. 8 is a block diagram illustrating the relationships and dependencies among parameters used for distributed broadcast isochronous stream (BIS) management in a group audio chat system, according to an example implementation of the present disclosure.

FIG. 9 is a diagram illustrating the hierarchical flow and succession of master, primary, and secondary device roles, according to an example implementation of the present disclosure.

FIG. 10 is a schematic diagram illustrating the structure and fields of a BIS PDU header and payload, according to an example implementation of the present disclosure.

FIG. 11 is a diagram illustrating the allocation and usage of BIS slots for audio transmission and control in a group audio chat system, according to an example implementation of the present disclosure.

FIG. 12 is a timing diagram illustrating the transition between active audio transmission, silence, and wireless transmission states for a device, according to an example implementation of the present disclosure.

FIG. 13 is a flowchart illustrating a method for establishing and managing a group communication session, according to an example implementation of the present disclosure.

FIG. 14 is a flowchart illustrating a method for transmitting audio in a group communication session, according to an example implementation of the present disclosure.

FIG. 15 is a flowchart illustrating a method for configuring a backup primary device, according to an example implementation of the present disclosure.

FIG. 16 is a flowchart illustrating a method for role transitioning from a backup primary device to a primary device, according to an example implementation of the present disclosure.

### DETAILED DESCRIPTION

Before turning to the figures, which illustrate certain embodiments in detail, it should be understood that the present disclosure is not limited to the details or methodology set forth in the description or illustrated in the figures. It should also be understood that the terminology used herein is for the purpose of description only and should not be regarded as limiting.

Wireless communication systems can support the exchange of data among multiple electronic devices using radio frequency links. Such systems can operate under various network topologies that include connection-oriented links, broadcast links, or combinations of both. In some environments, audio data can be transmitted among multiple devices to support applications, such as live conferencing, voice collaboration, or shared multimedia playback. Wireless Personal Area Network (WPAN)-based protocols can provide convenient mechanisms for low-power wireless audio communication and are widely adopted across consumer electronic devices. Some broadcast modes can transmit audio from a single origin device to multiple receivers without creating individual pairing relationships, allowing a single audio source to reach many listeners concurrently.

Some WPAN broadcast systems can, however, be limited in scenarios that require bidirectional communication among multiple participants. Some unidirectional architectures can transmit audio in one direction, but they are not structured to coordinate multiple concurrent transmitters. Techniques relying on connection-oriented pairing can support two-way communication, but such techniques can create scalability and management challenges. Device pairing can increase setup complexity, limit the number of simultaneous participants, and introduce significant overhead to maintain time coordination. Some unicast and broadcast approaches can also depend on a single transmitter reference, creating susceptibility to synchronization loss or session termination when the master device leaves the communication range or becomes unavailable. Furthermore, some systems may not provide an adaptive mechanism for allocating bandwidth based on voice activity, nor do they maintain low-latency continuity across mobile or intermittent connections.

The techniques described herein can provide an approach for establishing decentralized group audio communication using broadcast transmission structures. The techniques can modify a broadcast framework such that multiple devices within a defined group can both transmit and receive audio data without connection-based pairing. Each device can operate as a transmitter or receiver according to group parameters shared through periodic broadcast synchronization signals. The techniques can incorporate distributed timing coordination and dynamic slot management that preserve broadcast scalability while introducing bidirectional exchange of audio streams among many devices.

In one conceptual arrangement, a primary device can broadcast periodic synchronization packets that include session identifiers and scheduling information. Secondary devices within range can detect these signals and autonomously join a broadcast isochronous group for participation. The primary device can coordinate a timing reference and optionally designate a backup source to maintain timing continuity. Each participating device can sense audio input through onboard sensors, generate an allocation request for an available transmission slot, and transmit audio data during the assigned slot. The broadcast timing structure can include intervals for active transmission and idle reception subframes, allowing all devices to conserve power while remaining synchronized. Communication resources can be statically or dynamically assigned according to voice activity, providing distributed time-division coordination without centralized connections.

Through this configuration, the techniques described herein can provide continuity of group communication under decentralized control. When a primary device becomes unavailable, a designated backup device can assume synchronization transmission, allowing other devices to maintain the established session. Clock data and group state can propagate throughout the cluster such that every participant maintains a synchronized perspective of timing and slot use. This group broadcast model can reduce dependency on connection-oriented links, support rapid session reformation, and accommodate many simultaneous devices with latency suitable for conversational audio. As a result, the disclosed techniques can overcome single-point failure issues, reduce connection overhead, and provide scalable low-power audio interaction among dynamically distributed WPAN devices.

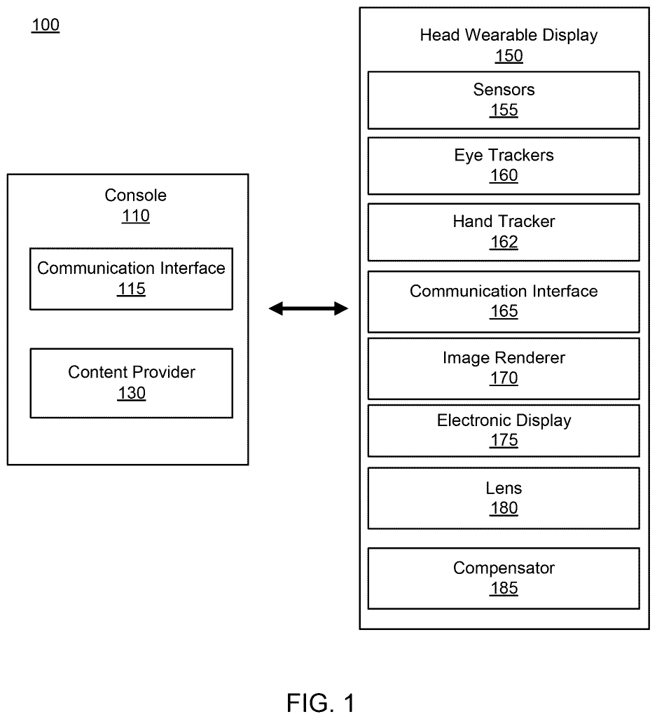

FIG. 1 is a block diagram of an example artificial reality system environment 100. In some embodiments, the artificial reality system environment 100 includes a HWD 150 worn by a user, and a console 110 providing content of artificial reality to the HWD 150. The HWD 150 may be referred to as, include, or be part of a head mounted display (HMD), head mounted device (HMD), head wearable device (HWD), head worn display (HWD) or head worn device (HWD). The HWD 150 may detect its location and/or orientation of the HWD 150 as well as a shape, location, and/or an orientation of the body/hand/face of the user, and provide the detected location/or orientation of the HWD 150 and/or tracking information indicating the shape, location, and/or orientation of the body/hand/face to the console 110. The console 110 may generate image data indicating an image of the artificial reality according to the detected location and/or orientation of the HDM 150, the detected shape, location and/or orientation of the body/hand/face of the user, and/or a user input for the artificial reality, and transmit the image data to the HWD 150 for presentation. In some embodiments, the artificial reality system environment 100 includes more, fewer, or different components than shown in FIG. 1. In some embodiments, functionality of one or more components of the artificial reality system environment 100 can be distributed among the components in a different manner than is described here. For example, some of the functionality of the console 110 may be performed by the HWD 150. For example, some of the functionality of the HWD 150 may be performed by the console 110. In some embodiments, the console 110 is integrated as part of the HWD 150.

In some embodiments, the HWD 150 is an electronic component that can be worn by a user and can present or provide an artificial reality experience to the user. The HWD 150 may render one or more images, video, audio, or some combination thereof to provide the artificial reality experience to the user. In some embodiments, audio is presented via an external device (e.g., speakers and/or headphones) that receives audio information from the HWD 150, the console 110, or both, and presents audio based on the audio information. In some embodiments, the HWD 150 includes sensors 155, eye trackers 160, a hand tracker 162, a communication interface 165, an image renderer 170, an electronic display 175, a lens 180, and a compensator 185. These components may operate together to detect a location of the HWD 150 and a gaze direction of the user wearing the HWD 150, and render an image of a view within the artificial reality corresponding to the detected location and/or orientation of the HWD 150. In other embodiments, the HWD 150 includes more, fewer, or different components than shown in FIG. 1.

In some embodiments, the sensors 155 include electronic components or a combination of electronic components and software components that detect a location and an orientation of the HWD 150. Examples of the sensors 155 can include: one or more imaging sensors, one or more accelerometers, one or more gyroscopes, one or more magnetometers, or another suitable type of sensor that detects motion and/or location. For example, one or more accelerometers can measure translational movement (e.g., forward/back, up/down, left/right) and one or more gyroscopes can measure rotational movement (e.g., pitch, yaw, roll). In some embodiments, the sensors 155 detect the translational movement and the rotational movement, and determine an orientation and location of the HWD 150. In one aspect, the sensors 155 can detect the translational movement and the rotational movement with respect to a previous orientation and location of the HWD 150, and determine a new orientation and/or location of the HWD 150 by accumulating or integrating the detected translational movement and/or the rotational movement. Assuming for an example that the HWD 150 is oriented in a direction 25 degrees from a reference direction, in response to detecting that the HWD 150 has rotated 20 degrees, the sensors 155 may determine that the HWD 150 now faces or is oriented in a direction 45 degrees from the reference direction. Assuming for another example that the HWD 150 was located two feet away from a reference point in a first direction, in response to detecting that the HWD 150 has moved three feet in a second direction, the sensors 155 may determine that the HWD 150 is now located at a vector multiplication of the two feet in the first direction and the three feet in the second direction.

In some embodiments, the eye trackers 160 include electronic components or a combination of electronic components and software components that determine a gaze direction of the user of the HWD 150. In some embodiments, the HWD 150, the console 110 or a combination of them may incorporate the gaze direction of the user of the HWD 150 to generate image data for artificial reality. In some embodiments, the eye trackers 160 include two eye trackers, where each eye tracker 160 captures an image of a corresponding eye and determines a gaze direction of the eye. In one example, the eye tracker 160 determines an angular rotation of the eye, a translation of the eye, a change in the torsion of the eye, and/or a change in shape of the eye, according to the captured image of the eye, and determines the relative gaze direction with respect to the HWD 150, according to the determined angular rotation, translation and the change in the torsion of the eye. In one approach, the eye tracker 160 may shine or project a predetermined reference or structured pattern on a portion of the eye, and capture an image of the eye to analyze the pattern projected on the portion of the eye to determine a relative gaze direction of the eye with respect to the HWD 150. In some embodiments, the eye trackers 160 incorporate the orientation of the HWD 150 and the relative gaze direction with respect to the HWD 150 to determine a gate direction of the user. Assuming for an example that the HWD 150 is oriented at a direction 30 degrees from a reference direction, and the relative gaze direction of the HWD 150 is −10 degrees (or 350 degrees) with respect to the HWD 150, the eye trackers 160 may determine that the gaze direction of the user is 20 degrees from the reference direction. In some embodiments, a user of the HWD 150 can configure the HWD 150 (e.g., via user settings) to enable or disable the eye trackers 160. In some embodiments, a user of the HWD 150 is prompted to enable or disable the eye trackers 160.

In some embodiments, the hand tracker 162 includes an electronic component or a combination of an electronic component and a software component that tracks a hand of the user. In some embodiments, the hand tracker 162 includes or is coupled to an imaging sensor (e.g., camera) and an image processor that can detect a shape, a location and an orientation of the hand. The hand tracker 162 may generate hand tracking measurements indicating the detected shape, location and orientation of the hand.

In some embodiments, the communication interface 165 includes an electronic component or a combination of an electronic component and a software component that communicates with the console 110. The communication interface 165 may communicate with a communication interface 115 of the console 110 through a communication link. The communication link may be a wireless link. Examples of the wireless link can include a cellular communication link, a near field communication link, Wi-Fi, Bluetooth, 60 GHz wireless link, or any communication wireless communication link. Through the communication link, the communication interface 165 may transmit to the console 110 data indicating the determined location and/or orientation of the HWD 150, the determined gaze direction of the user, and/or hand tracking measurement. Moreover, through the communication link, the communication interface 165 may receive from the console 110 image data indicating or corresponding to an image to be rendered and additional data associated with the image.

In some embodiments, the image renderer 170 includes an electronic component or a combination of an electronic component and a software component that generates one or more images for display, for example, according to a change in view of the space of the artificial reality. In some embodiments, the image renderer 170 is implemented as a processor (or a graphical processing unit (GPU)) that executes instructions to perform various functions described herein. The image renderer 170 may receive, through the communication interface 165, image data describing an image of artificial reality to be rendered and additional data associated with the image, and render the image through the electronic display 175. In some embodiments, the image data from the console 110 may be encoded, and the image renderer 170 may decode the image data to render the image. In some embodiments, the image renderer 170 receives, from the console 110 in additional data, object information indicating virtual objects in the artificial reality space and depth information indicating depth (or distances from the HWD 150) of the virtual objects. In one aspect, according to the image of the artificial reality, object information, depth information from the console 110, and/or updated sensor measurements from the sensors 155, the image renderer 170 may perform shading, reprojection, and/or blending to update the image of the artificial reality to correspond to the updated location and/or orientation of the HWD 150. Assuming that a user rotated his head after the initial sensor measurements, rather than recreating the entire image responsive to the updated sensor measurements, the image renderer 170 may generate a small portion (e.g., 10 %) of an image corresponding to an updated view within the artificial reality according to the updated sensor measurements, and append the portion to the image in the image data from the console 110 through reprojection. The image renderer 170 may perform shading and/or blending on the appended edges. Hence, without recreating the image of the artificial reality according to the updated sensor measurements, the image renderer 170 can generate the image of the artificial reality. In some embodiments, the image renderer 170 receives hand model data indicating a shape, a location and an orientation of a hand model corresponding to the hand of the user, and overlay the hand model on the image of the artificial reality. Such hand model may be presented as a visual feedback to allow a user to provide various interactions within the artificial reality.

In some embodiments, the electronic display 175 is an electronic component that displays an image. The electronic display 175 may, for example, be a liquid crystal display or an organic light emitting diode display. The electronic display 175 may be a transparent display that allows the user to see through. In some embodiments, when the HWD 150 is worn by a user, the electronic display 175 is located proximate (e.g., less than 3 inches) to the user's eyes. In one aspect, the electronic display 175 emits or projects light towards the user's eyes according to image generated by the image renderer 170.

In some embodiments, the lens 180 is a mechanical component that alters received light from the electronic display 175. The lens 180 may magnify the light from the electronic display 175, and correct for optical error associated with the light. The lens 180 may be a Fresnel lens, a convex lens, a concave lens, a filter, or any suitable optical component that alters the light from the electronic display 175. Through the lens 180, light from the electronic display 175 can reach the pupils, such that the user can see the image displayed by the electronic display 175, despite the close proximity of the electronic display 175 to the eyes.

In some embodiments, the compensator 185 includes an electronic component or a combination of an electronic component and a software component that performs compensation to compensate for any distortions or aberrations. In one aspect, the lens 180 introduces optical aberrations such as a chromatic aberration, a pin-cushion distortion, barrel distortion, etc. The compensator 185 may determine a compensation (e.g., predistortion) to apply to the image to be rendered from the image renderer 170 to compensate for the distortions caused by the lens 180, and apply the determined compensation to the image from the image renderer 170. The compensator 185 may provide the predistorted image to the electronic display 175.

In some embodiments, the console 110 is an electronic component or a combination of an electronic component and a software component that provides content to be rendered to the HWD 150. In one aspect, the console 110 includes a communication interface 115 and a content provider 130. These components may operate together to determine a view (e.g., a FOV of the user) of the artificial reality corresponding to the location of the HWD 150 and the gaze direction of the user of the HWD 150, and can generate image data indicating an image of the artificial reality corresponding to the determined view. In addition, these components may operate together to generate additional data associated with the image. Additional data may be information associated with presenting or rendering the artificial reality other than the image of the artificial reality. Examples of additional data include, hand model data, mapping information for translating a location and an orientation of the HWD 150 in a physical space into a virtual space (or simultaneous localization and mapping (SLAM) data), eye tracking data, motion vector information, depth information, edge information, object information, etc. The console 110 may provide the image data and the additional data to the HWD 150 for presentation of the artificial reality. In other embodiments, the console 110 includes more, fewer, or different components than shown in FIG. 1. In some embodiments, the console 110 is integrated as part of the HWD 150.

In some embodiments, the communication interface 115 is an electronic component or a combination of an electronic component and a software component that communicates with the HWD 150. The communication interface 115 may be a counterpart component to the communication interface 165 to communicate with a communication interface 115 of the console 110 through a communication link (e.g., wireless link). Through the communication link, the communication interface 115 may receive from the HWD 150 data indicating the determined location and/or orientation of the HWD 150, the determined gaze direction of the user, and the hand tracking measurement. Moreover, through the communication link, the communication interface 115 may transmit to the HWD 150 image data describing an image to be rendered and additional data associated with the image of the artificial reality.

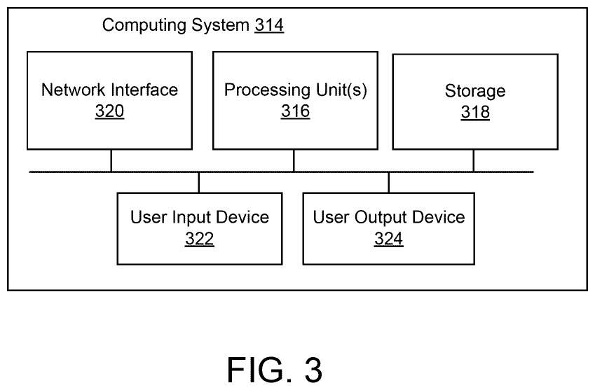

The content provider 130 can include or correspond to a component that generates content to be rendered according to the location and/or orientation of the HWD 150. In some embodiments, the content provider 130 may incorporate the gaze direction of the user of the HWD 150, and a user interaction in the artificial reality based on hand tracking measurements to generate the content to be rendered. In one aspect, the content provider 130 determines a view of the artificial reality according to the location and/or orientation of the HWD 150. For example, the content provider 130 maps the location of the HWD 150 in a physical space to a location within an artificial reality space, and determines a view of the artificial reality space along a direction corresponding to the mapped orientation from the mapped location in the artificial reality space. The content provider 130 may generate image data describing an image of the determined view of the artificial reality space, and transmit the image data to the HWD 150 through the communication interface 115. The content provider 130 may also generate a hand model corresponding to a hand of a user of the HWD 150 according to the hand tracking measurement, and generate hand model data indicating a shape, a location, and an orientation of the hand model in the artificial reality space. In some embodiments, the content provider 130 may generate additional data including motion vector information, depth information, edge information, object information, hand model data, etc., associated with the image, and transmit the additional data together with the image data to the HWD 150 through the communication interface 115. The content provider 130 may encode the image data describing the image, and can transmit the encoded data to the HWD 150. In some embodiments, the content provider 130 generates and provides the image data to the HWD 150 periodically (e.g., every 11 ms). In one aspect, the communication interface 115 can adaptively transmit the additional data to the HWD 150 as described below with respect to FIGS. 3 through 6.

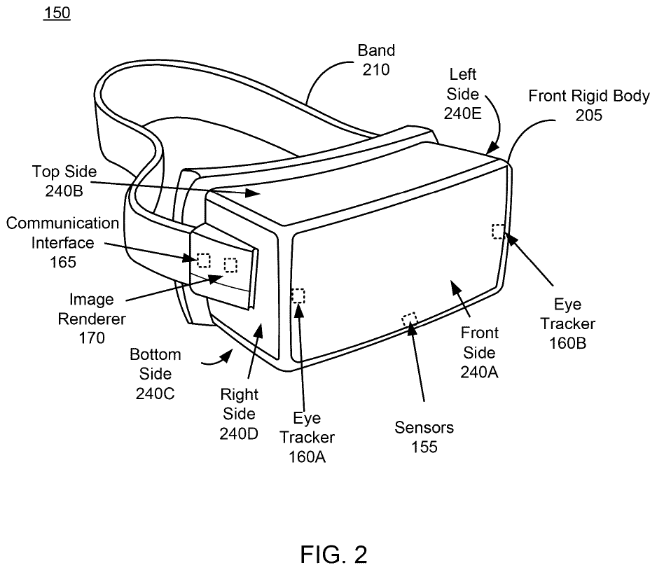

FIG. 2 is a diagram of a HWD 150, in accordance with an example embodiment. In some embodiments, the HWD 150 includes a front rigid body 205 and a band 210. The front rigid body 205 includes the electronic display 175 (not shown in FIG. 2), the lens 180 (not shown in FIG. 2), the sensors 155, the eye trackers 160A, 160B, the communication interface 165, and the image renderer 170. In the embodiment shown by FIG. 2, the communication interface 165, the image renderer 170, and the sensors 155 are located within the front rigid body 205, and may not visible to the user. In other embodiments, the HWD 150 has a different configuration than shown in FIG. 2. For example, the communication interface 165, the image renderer 170, the eye trackers 160A, 160B, and/or the sensors 155 may be in different locations than shown in FIG. 2.

Various operations described herein can be implemented on computer systems. FIG. 3 shows a block diagram of a representative computing system 314 usable to implement the present disclosure. In some embodiments, the console 110, the HWD 150 or both of FIG. 1 are implemented by the computing system 314. Computing system 314 can be implemented, for example, as a consumer device such as a smartphone, other mobile phone, tablet computer, wearable computing device (e.g., smart watch, eyeglasses, head wearable display), desktop computer, laptop computer, or implemented with distributed computing devices. The computing system 314 can be implemented to provide VR, AR, MR experience. In some embodiments, the computing system 314 can include conventional computer components such as processors 316, storage device 318, network interface 320, user input device 322, and user output device 324.

Network interface 320 can provide a connection to a wide area network (e.g., the Internet) to which WAN interface of a remote server system is also connected. Network interface 320 can include a wired interface (e.g., Ethernet) and/or a wireless interface implementing various RF data communication standards such as Wi-Fi, Bluetooth, or cellular data network standards (e.g., 3G, 4G, 5G, 60 GHz, LTE, etc.).

User input device 322 can include any device (or devices) via which a user can provide signals to computing system 314; computing system 314 can interpret the signals as indicative of particular user requests or information. User input device 322 can include any or all of a keyboard, touch pad, touch screen, mouse or other pointing device, scroll wheel, click wheel, dial, button, switch, keypad, microphone, sensors (e.g., a motion sensor, an eye tracking sensor, etc.), and so on.

User output device 324 can include any device via which computing system 314 can provide information to a user. For example, user output device 324 can include a display to display images generated by or delivered to computing system 314. The display can incorporate various image generation technologies, e.g., a liquid crystal display (LCD), light-emitting diode (LED) including organic light-emitting diodes (OLED), projection system, cathode ray tube (CRT), or the like, together with supporting electronics (e.g., digital-to-analog or analog-to-digital converters, signal processors, or the like). A device such as a touchscreen that function as both input and output device can be used. Output devices 324 can be provided in addition to or instead of a display. Examples include indicator lights, speakers, tactile “display” devices, printers, and so on.

Some implementations include electronic components, such as microprocessors, storage and memory that store computer program instructions in a computer readable storage medium (e.g., non-transitory computer readable medium). Many of the features described in this specification can be implemented as processes that are specified as a set of program instructions encoded on a computer readable storage medium. When these program instructions are executed by one or more processors, they cause the processors to perform various operation indicated in the program instructions. Examples of program instructions or computer code include machine code, such as is produced by a compiler, and files including higher-level code that are executed by a computer, an electronic component, or a microprocessor using an interpreter. Through suitable programming, processor 316 can provide various functionality for computing system 314, including any of the functionality described herein as being performed by a server or client, or other functionality associated with message management services.

It will be appreciated that computing system 314 is illustrative and that variations and modifications are possible. Computer systems used in connection with the present disclosure can have other capabilities not specifically described here. Further, while computing system 314 is described with reference to particular blocks, it is to be understood that these blocks are defined for convenience of description and are not intended to imply a particular physical arrangement of component parts. For instance, different blocks can be located in the same facility, in the same server rack, or on the same motherboard. Further, the blocks need not correspond to physically distinct components. Blocks can be configured to perform various operations, e.g., by programming a processor or providing appropriate control circuitry, and various blocks might or might not be reconfigurable depending on how the initial configuration is obtained. Implementations of the present disclosure can be realized in a variety of apparatus including electronic devices implemented using any combination of circuitry and software.

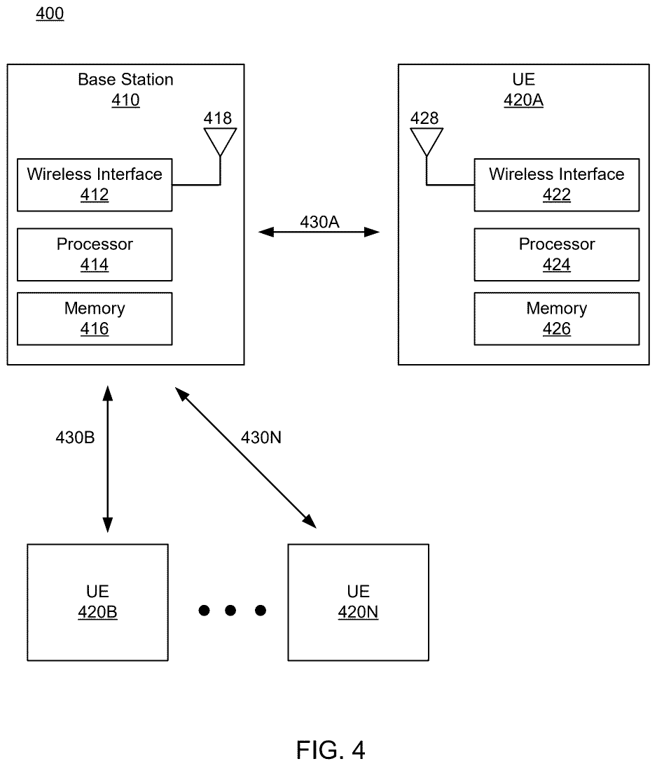

FIG. 4 illustrates an example wireless communication system 400. The wireless communication system 400 may include a base station 410 (also referred to as “a wireless communication node 410” or “a station 410”) and one or more user equipment (UEs) 420 (also referred to as “wireless communication devices 420” or “terminal devices 420”). The UEs 420 may be or include any device or component described above with reference to FIG. 1-FIG. 3, such as the console 110, head wearable display 150, or the like. The base station 410 and UEs 420 may include components, elements, and/or hardware similar to those described above with reference to FIG. 1-FIG. 3. The base station 410 and the UEs 420 may communicate through wireless commination links 430A, 430B, 430C. The wireless communication link 430 may be a cellular communication link conforming to 3G, 4G, 5G or other cellular communication protocols or a Wi-Fi communication protocol. In one example, the wireless communication link 430 supports, employs or is based on an orthogonal frequency division multiple access (OFDMA). In one aspect, the UEs 420 are located within a geographical boundary with respect to the base station 410, and may communicate with or through the base station 410. In some embodiments, the wireless communication system 400 includes more, fewer, or different components than shown in FIG. 4. For example, the wireless communication system 400 may include one or more additional base stations 410 than shown in FIG. 4.

In some embodiments, the UE 420 may be a user device such as a mobile phone, a smart phone, a personal digital assistant (PDA), tablet, laptop computer, wearable computing device, etc. Each UE 420 may communicate with the base station 410 through a corresponding communication link 430. For example, the UE 420 may transmit data to a base station 410 through a wireless communication link 430, and receive data from the base station 410 through the wireless communication link 430. Example data may include audio data, image data, text, etc. Communication or transmission of data by the UE 420 to the base station 410 may be referred to as an uplink communication. Communication or reception of data by the UE 420 from the base station 410 may be referred to as a downlink communication. In some embodiments, the UE 420A includes a wireless interface 422, a processor 424, a memory device 426, and one or more antennas 428. These components may be embodied as hardware, software, firmware, or a combination thereof. In some embodiments, the UE 420A includes more, fewer, or different components than shown in FIG. 4. For example, the UE 420 may include an electronic display and/or an input device. For example, the UE 420 may include additional antennas 428 and wireless interfaces 422 than shown in FIG. 4.

The antenna 428 may be a component that receives a radio frequency (RF) signal and/or transmit a RF signal through a wireless medium. The RF signal may be at a frequency between 200 MHz to 100 GHz. The RF signal may have packets, symbols, or frames corresponding to data for communication. The antenna 428 may be a dipole antenna, a patch antenna, a ring antenna, or any suitable antenna for wireless communication. In one aspect, a single antenna 428 is utilized for both transmitting the RF signal and receiving the RF signal. In one aspect, different antennas 428 are utilized for transmitting the RF signal and receiving the RF signal. In one aspect, multiple antennas 428 are utilized to support multiple-in, multiple-out (MIMO) communication.

The wireless interface 422 includes or is embodied as a transceiver for transmitting and receiving RF signals through a wireless medium. The wireless interface 422 may communicate with a wireless interface 412 of the base station 410 through a wireless communication link 430A. In one configuration, the wireless interface 422 is coupled to one or more antennas 428. In one aspect, the wireless interface 422 may receive the RF signal at the RF frequency received through antenna 428, and downconvert the RF signal to a baseband frequency (e.g., 0˜1 GHz). The wireless interface 422 may provide the downconverted signal to the processor 424. In one aspect, the wireless interface 422 may receive a baseband signal for transmission at a baseband frequency from the processor 424, and upconvert the baseband signal to generate a RF signal. The wireless interface 422 may transmit the RF signal through the antenna 428.

The processor 424 is a component that processes data. The processor 424 may be embodied as field programmable gate array (FPGA), application specific integrated circuit (ASIC), a logic circuit, etc. The processor 424 may obtain instructions from the memory device 426, and executes the instructions. In one aspect, the processor 424 may receive downconverted data at the baseband frequency from the wireless interface 422, and decode or process the downconverted data. For example, the processor 424 may generate audio data or image data according to the downconverted data, and present an audio indicated by the audio data and/or an image indicated by the image data to a user of the UE 420A. In one aspect, the processor 424 may generate or obtain data for transmission at the baseband frequency, and encode or process the data. For example, the processor 424 may encode or process image data or audio data at the baseband frequency, and provide the encoded or processed data to the wireless interface 422 for transmission.

The memory device 426 is a component that stores data. The memory device 426 may be embodied as random access memory (RAM), flash memory, read only memory (ROM), erasable programmable read-only memory (EPROM), electrically erasable programmable read-only memory (EEPROM), registers, a hard disk, a removable disk, a CD-ROM, or any device capable for storing data. The memory device 426 may be embodied as a non-transitory computer readable medium storing instructions executable by the processor 424 to perform various functions of the UE 420A disclosed herein. In some embodiments, the memory device 426 and the processor 424 are integrated as a single component.

In some embodiments, each of the UEs 420B . . . 420N includes similar components of the UE 420A to communicate with the base station 410. Thus, detailed description of duplicated portion thereof is omitted herein for the sake of brevity.

In some embodiments, the base station 410 may be an evolved node B (eNB), a serving eNB, a target eNB, a femto station, or a pico station. The base station 410 may be communicatively coupled to another base station 410 or other communication devices through a wireless communication link and/or a wired communication link. The base station 410 may receive data (or a RF signal) in an uplink communication from a UE 420. Additionally or alternatively, the base station 410 may provide data to another UE 420, another base station, or another communication device. Hence, the base station 410 allows communication among UEs 420 associated with the base station 410, or other UEs associated with different base stations. In some embodiments, the base station 410 includes a wireless interface 412, a processor 414, a memory device 416, and one or more antennas 418. These components may be embodied as hardware, software, firmware, or a combination thereof. In some embodiments, the base station 410 includes more, fewer, or different components than shown in FIG. 4. For example, the base station 410 may include an electronic display and/or an input device. For example, the base station 410 may include additional antennas 418 and wireless interfaces 412 than shown in FIG. 4.

The antenna 418 may be a component that receives a radio frequency (RF) signal and/or transmit a RF signal through a wireless medium. The antenna 418 may be a dipole antenna, a patch antenna, a ring antenna, or any suitable antenna for wireless communication. In one aspect, a single antenna 418 is utilized for both transmitting the RF signal and receiving the RF signal. In one aspect, different antennas 418 are utilized for transmitting the RF signal and receiving the RF signal. In one aspect, multiple antennas 418 are utilized to support multiple-in, multiple-out (MIMO) communication.

The wireless interface 412 includes or is embodied as a transceiver for transmitting and receiving RF signals through a wireless medium. The wireless interface 412 may communicate with a wireless interface 422 of the UE 420 through a wireless communication link 430. In one configuration, the wireless interface 412 is coupled to one or more antennas 418. In one aspect, the wireless interface 412 may receive the RF signal at the RF frequency received through antenna 418, and downconvert the RF signal to a baseband frequency (e.g., 0˜1 GHz). The wireless interface 412 may provide the downconverted signal to the processor 424. In one aspect, the wireless interface 422 may receive a baseband signal for transmission at a baseband frequency from the processor 414, and upconvert the baseband signal to generate a RF signal. The wireless interface 412 may transmit the RF signal through the antenna 418.

The processor 414 is a component that processes data. The processor 414 may be embodied as FPGA, ASIC, a logic circuit, etc. The processor 414 may obtain instructions from the memory device 416, and executes the instructions. In one aspect, the processor 414 may receive downconverted data at the baseband frequency from the wireless interface 412, and decode or process the downconverted data. For example, the processor 414 may generate audio data or image data according to the downconverted data. In one aspect, the processor 414 may generate or obtain data for transmission at the baseband frequency, and encode or process the data. For example, the processor 414 may encode or process image data or audio data at the baseband frequency, and provide the encoded or processed data to the wireless interface 412 for transmission. In one aspect, the processor 414 may set, assign, schedule, or allocate communication resources for different UEs 420. For example, the processor 414 may set different modulation schemes, time slots, channels, frequency bands, etc. for UEs 420 to avoid interference. The processor 414 may generate data (or UL CGs) indicating configuration of communication resources, and provide the data (or UL CGs) to the wireless interface 412 for transmission to the UEs 420.

The memory device 416 is a component that stores data. The memory device 416 may be embodied as RAM, flash memory, ROM, EPROM, EEPROM, registers, a hard disk, a removable disk, a CD-ROM, or any device capable for storing data. The memory device 416 may be embodied as a non-transitory computer readable medium storing instructions executable by the processor 414 to perform various functions of the base station 410 disclosed herein. In some embodiments, the memory device 416 and the processor 414 are integrated as a single component.

In some embodiments, communication between the base station 410 and the UE 420 is based on one or more layers of Open Systems Interconnection (OSI) model. The OSI model may include layers including: a physical layer, a Medium Access Control (MAC) layer, a Radio Link Control (RLC) layer, a Packet Data Convergence Protocol (PDCP) layer, a Radio Resource Control (RRC) layer, a Non Access Stratum (NAS) layer or an Internet Protocol (IP) layer, and other layer.

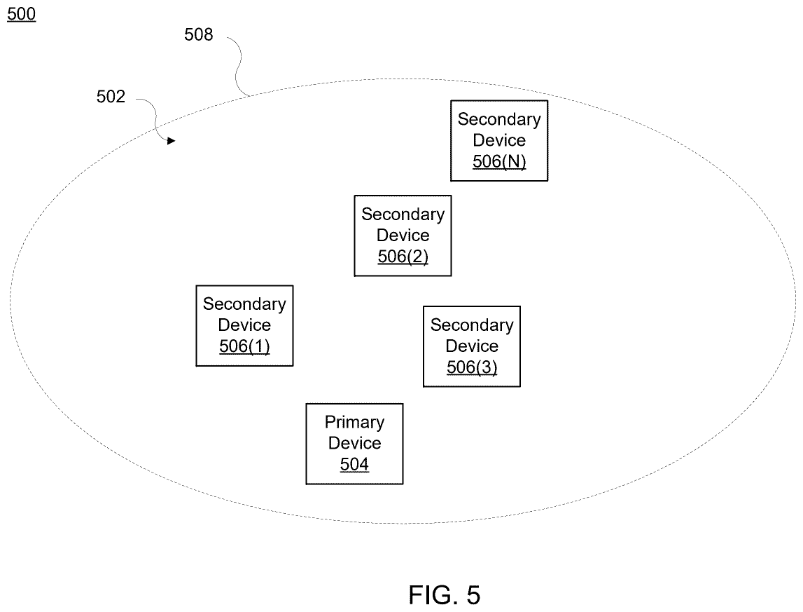

Referring now to FIG. 5, illustrated is a schematic diagram of a system 500 depicting a device group 502 participating in a decentralized group audio chat session. In general, the disclosed concepts relate to systems, methods, and computer-readable media that facilitate decentralized, connectionless, bidirectional audio communication among multiple devices within a broadcast network environment. These systems support synchronization, dynamic resource allocation, role succession, and onboarding processes to maintain continuous real-time group communication. The device group 502 can include a primary device 504 and one or more secondary devices 506(1)-506(N), collectively operating within a communication boundary or range 508 defining the wireless transmission zone.

The device group 502 can be or include any number of participating devices that can enter or exit the communication range 508 during operation. The device group 502 can accept new devices when those devices receive a synchronization signal transmitted by the primary device 504 and/or a backup primary device. The requesting device may issue a join message within an available anchor broadcast isochronous stream (BIS) slot. In some implementations, devices that move into range (e.g., within any of the devices within the device group 502) can automatically synchronize to the most recent broadcast parameters of the group and participate in the communication session, without pairing or dedicated connection setup. For example, a mobile handset moving into the communication boundary or range 508 can scan the periodic advertising broadcast by the primary device 504 to align its clock, and transmit a join message identifying its device ID and rank.

In some implementations, devices within the device group 502 can maintain participation as one or more members temporarily fall outside the communication boundary 508. For example, a secondary device that moves out of range can retain timing data and periodically scan for synchronization broadcasts to rejoin the same session upon re-entry. During such intervals, the remaining devices may continue transmitting keepalive beacons so that returning devices can re-establish synchronization without restarting the group. In another example, if multiple devices move together outside the effective range, those devices can temporarily form a smaller active subset using the stored broadcast identifiers until reconnection occurs. Thus, the device group 502 can provide continuous operation under mobile conditions by supporting fluid membership and automatic recovery across communication zones.

The primary device 504 can be or include an electronic device that initially establishes and maintains the device group 502 within a decentralized audio communication environment. The primary device 504 may include the hardware, components, and elements described with reference to FIGS. 1 through 3, including one or more processors, memory devices, and transceivers. In some implementations, the primary device 504 can include a Wireless Personal Area Network (WPAN) transceiver (such as a BLUETOOTH transceiver), configured to broadcast synchronization signals and manage timing among nearby participant devices. For example, the primary device 504 can correspond to a head-worn display, smartphone, or portable computing device that executes stored program instructions to coordinate group participation and maintain clock alignment within a broadcast isochronous group (BIG). The primary device 504 may further include power management and timing circuitry that supports periodic advertising intervals and maintains bidirectional communication compatibility with secondary devices 506(1)-506(N) across a defined communication boundary 508.

The primary device 504 can perform control operations to establish, configure, and sustain participation of devices in the device group 502. The primary device 504 may initiate the session by generating a synchronization signal that includes a session identifier, timing reference, and initial slot assignment data. The primary device 504 may initiate the session in response to a request by a user of the primary device 504 (e.g., a request on an application / resource/service of the primary device 504 to initiate the session). In some implementations, the primary device 504 can detect join requests from secondary devices and allocate broadcast isochronous stream (BIS) slots to those devices based on voice activity or predetermined resource policy. For example, the primary device 504 may receive a join message containing a device ID and authentication data, update its allocation table, and transmit an updated synchronization packet that reflects the new participant's slot information. The primary device 504 may periodically rebroadcast clock offset, payload counter, and hierarchy identifiers to maintain time coherence throughout the group, and may designate one of the secondary devices as a backup primary for continuity in the event of failure or out-of-range conditions. Through these operations, the primary device 504 can sustain a structured broadcast network that supports autonomous admission, dynamic resource allocation, and resilient group synchronization.

Each secondary device 506(1)-506(N) can be or include any other devices within the device group 502 that operates in coordination with the primary device 504. In some implementations, each secondary device 506(1)-506(N) may include the same/similar general processing, transceiver, and timing circuitry as the primary device 504, but can operate under the timing and synchronization offsets transmitted in the periodic broadcast from the primary device 504. For example, a secondary device 506(1)-506(N) can be a wearable headset, microphone accessory, smartphone, or any personal audio device capable of/configured for sensing audio input and participating in group communication through broadcast isochronous stream (BIS) events maintained by the primary device 504. In some embodiments, each secondary device 506(1)-506(N) may operate as both a receiver and an occasional transmitter during assigned slots, maintaining synchronization through updates received from the primary device 504 or a designated backup clock source. In this arrangement, the secondary devices 506(1)-506(N) can collectively sustain distributed bidirectional communication within the session while preserving a hierarchical timing structure referenced to the primary device 504. In some embodiments, a secondary device 506 may operate as a receiver, without transmit capabilities, in instances in which the secondary device 506 does not support transmission/broadcasting of audio data, as described in greater detail below.

As a general overview, secondary devices 506 may request to join a device group (e.g., via various join request mechanisms described in greater detail below). When a secondary device 506 detects voice activity locally on the device 506, the secondary device 506 can transmit a slot allocation request, and upon confirmation, begin audio transmission aligned to the BIS timing intervals. The secondary devices 506 may receive/identify/obtain timing correction from the synchronization signal and/or through derived clock propagation from a neighboring device in the clock hierarchy. In some embodiments, a secondary device 506 can assume a backup master role when communication lapses from the primary device, thereby continuing synchronization broadcasts without interruption of audio streaming.

The communication boundary 508 can define the effective wireless region used for maintaining broadcast participation among devices in the device group 502. The communication boundary 508 can represent the maximum range within which synchronization signals and broadcast isochronous stream events may be exchanged among the primary device 504 and secondary devices 506(1)-506(N). In some implementations, the communication boundary 508 can correspond to the physical limits of a wireless personal area network operating under a specific PHY layer or channel configuration. For example, when the primary device 504 transmits periodic synchronization signals, only devices within the communication boundary 508 can receive those signals and participate in the group session. In another example, the communication boundary 508 can adapt automatically through modulation and coding scheme changes or transmitter power adjustments, allowing participation to remain stable under variable ambient conditions.

In some implementations, the communication boundary 508 can vary dynamically based on the spatial distribution and radio characteristics of the device group 502. For example, when devices 504, 506 are spaced widely apart, the communication boundary 508 can expand through coded or long-range PHY mode selection to maintain mutual synchronization. In another example, when devices 504, 506 are closely located, the communication boundary 508 can contract to form a denser cluster that reduces power consumption and minimizes interference with overlapping groups. In some implementations, secondary devices 506(1)-506(N) may operate in a daisy-chain configuration where one device 506 rebroadcasts synchronization signals received from another device 506, effectively extending the communication boundary 508 while maintaining alignment of broadcast timing and session identifiers across a larger operational area.

When one or more devices 504, 506 move beyond the communication boundary 508 of a broadcast isochronous group, each affected device can execute a recovery sequence to maintain participation in the ongoing session. In some implementations, when a device loses reception from only a primary device 504 or a secondary device 506 acting as a clock source, the device can transmit periodic status messages during an anchor broadcast interval to indicate the missing synchronization reference. For example, the device may broadcast a control packet reporting that the timing hierarchy no longer includes the identifier of the primary device 504, prompting the remaining in-range secondary devices 506(1)-506(N) to adapt transmission parameters or modify physical layer settings to reestablish operation. The out-of-range device may continue to transmit such status packets for a defined timeout while ceasing audio transmission until valid synchronization is restored.

When a device no longer receives transmissions from both the primary device 504 and any secondary device 506 serving as a clock reference, the device can enter a scanning state to identify alternative periodic advertisements associated with the same broadcast isochronous group. In some implementations, the out-of-range device can intermittently broadcast auxiliary advertisement packets indicating stored timing data, including the last known broadcast isochronous group offset and broadcast isochronous stream payload count values. For example, once a valid advertisement is detected, the device can transmit a status acknowledgment during the corresponding broadcast interval and discontinue auxiliary advertisements after a timeout or confirmation of reintegration. In another example, when the scanning device receives a status message from another detached secondary device, the scanning device may assume a temporary master role and initiate a localized subgroup operating under preserved broadcast identifiers so that detached devices remain synchronized while disconnected from the primary device 504.

From the perspective of devices still within range 508, reception of out-of-range status indications can initiate preparation for session merging procedures. In some implementations, in-range devices can share scanning responsibilities or temporarily widen physical layer coverage to detect separated subgroups. For example, after valid advertising signals from rejoining devices are observed, the primary device 504 may broadcast a merge notification including updated clock parameters and timing offsets to reintegrate all participants under the original synchronization framework. Such operations may maintain continuity of group communication as secondary devices 506(1)-506(N) transition outside and back within coverage areas without reinitializing the broadcast isochronous group.

In some implementations, to compensate for reduced range or degraded reception conditions, the device group 502 can employ physical layer adaptation processes. For example, the primary device 504 may transmit a notification to switch from a low energy WPAN (e.g., BLE) 2M physical layer (PHY) to a coded 1M PHY mode (S=2) to increase link margin when signal degradation or interference exceeds a threshold. In some implementations, the primary device 504 can include a countdown field within periodic advertisements to indicate the epoch at which the PHY transition will occur, after which secondary devices 506(1)-506(N) can retune while maintaining anchor broadcast alignment. For example, the devices may selectively migrate broadcast isochronous streams to the coded 1M PHY mode for extended reach or, in another example, shift all advertisements and control transmissions to the same coded 1M PHY mode for improved outdoor reliability. The broadcast isochronous group can further conserve energy or balance reliability by adjusting the symbol encoding (NSE) and link persistence parameters in response to interference conditions.

In some implementations, transmit authorization among devices within the communication boundary 508 can be managed through cryptographic access control. For example, devices possessing valid broadcast encryption keys can receive transmissions, while transmit authority may be restricted to specific secondary devices 506 or to the primary device 504. For instance, under arrangements that include a persistent primary device 504 acting as a controller, asymmetric encryption may permit only authorized devices to broadcast audio to the group, while distributed groups may use symmetric encryption and rely on local consensus to control transmission activity. Additionally, certain secondary devices 506 can function as relay devices that retransmit received broadcast isochronous streams 814 to extend effective range or improve reliability. A relay device may activate dynamically based on packet-loss statistics broadcast in control data. In another example, a secondary device 506 including multiple antennas may alternate broadcast transmissions between antennas and/or select an optimal reception antenna per isochronous interval to support spatial diversity and determine angle-of-arrival information for spatialized audio.

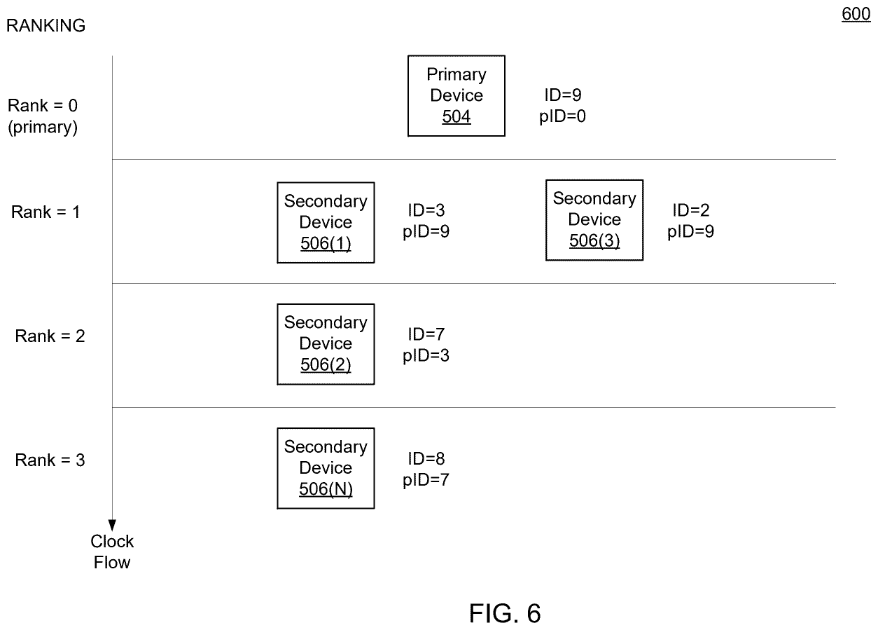

Referring now to FIG. 6, illustrated is a diagram 600 depicting hierarchical ranking for clock synchronization among devices in the device group 502 described with respect to FIG. 5. The diagram 600 can include a primary device 504 and one or more secondary devices 506(1)-506(N), each maintaining a respective rank value and parent identifier value within a distributed timing hierarchy. The arrows in the figure may indicate clock flow between lower and higher rank devices, representing the propagation of synchronization references throughout the hierarchy.

In general, time synchronization is required among all devices within the device group shown in FIG. 6 so that transmissions generated by the devices do not overlap in time. The hierarchical structure of FIG. 6 can include a primary device 504 identified by ID=9 and parent ID (pID)=0 at rank 0, one or more secondary devices 506 having distinct identifiers and parent references such as ID=3 (pID=9) at rank 1, ID=7 (pID=3) at rank 2, and ID=8 (pID=7) at rank 3. Each secondary device 506 can receive its synchronization signal from the immediate superior in the hierarchy to maintain deterministic offsets between transmit and receive intervals and avoid collision within broadcast isochronous stream (BIS) windows. In some implementations, multiple devices can transmit BIS streams concurrently in an overtalk control scenario, in which the orthogonality of assigned transmit slots allows a single time-division duplex (TDD) wireless personal area network (WPAN) chip to transmit and receive multiple isochronous packets at non-overlapping time offsets. For example, the secondary device 506(1) having ID=3 may transmit at a fixed ISO interval aligned to the offset defined by the parent device (e.g., primary device 504), while device 506(2) having ID=7 may simultaneously receive audio from the primary device 504 using an adjacent time slot within the same BIG interval.

Each device can broadcast its device ID, rank value, and parent ID within control data so that other devices can reconstruct the timing hierarchy and validate synchronization sources. When the primary device 504 becomes unavailable, a secondary device 506, such as the device 506(1) with ID=3 and rank 1, may temporarily operate as a fallback clock source for downstream devices 506(2), 506(N). In some implementations, a secondary device 506 can determine absence of timing packets from the primary device 504, and subsequently promote itself to the primary role, initiating rebroadcast of clock reference information to maintain synchronization continuity. For example, once a device at rank 1 (such as the secondary device 506(1), 506(3)) determines that a periodic advertising or payload counter signal from the primary device 504 has not been received (e.g., after a predetermined duration/timeout period), the device 506 can establish/use a clock signal (e.g., locally) and broadcast updated BIG offset values that preserve the original deterministic interval for each subordinate device 506. Other secondary units at lower ranks can tune to this new clock source until communication with the original primary device 504 resumes, thereby sustaining the distributed synchronization hierarchy.

During idle phases without active audio, each device 504, 506 may perform subrated transmissions at extended cadences to conserve energy while keeping synchronization within acceptable drift bounds. In this subrated condition, the secondary devices 506 can transmit periodic anchor BIS frames spaced at larger intervals (for example, 100 ms) to distribute updated clock trim and offset parameters. Such link-maintenance transmissions can sustain alignment even where gaps occur in active payload delivery. When voice activity resumes, the devices 504, 506 can resume shorter (e.g., 10 ms) BIS intervals, during which receive-side frequency tracking loops can converge to restore full synchronization. In some implementations, gating or muting of initial audio frames may be avoided while the devices 504, 506 reacquire timing, since early convergence with slight deviation may yield more continuous audio than gating over the first ≈100 ms of recovery.

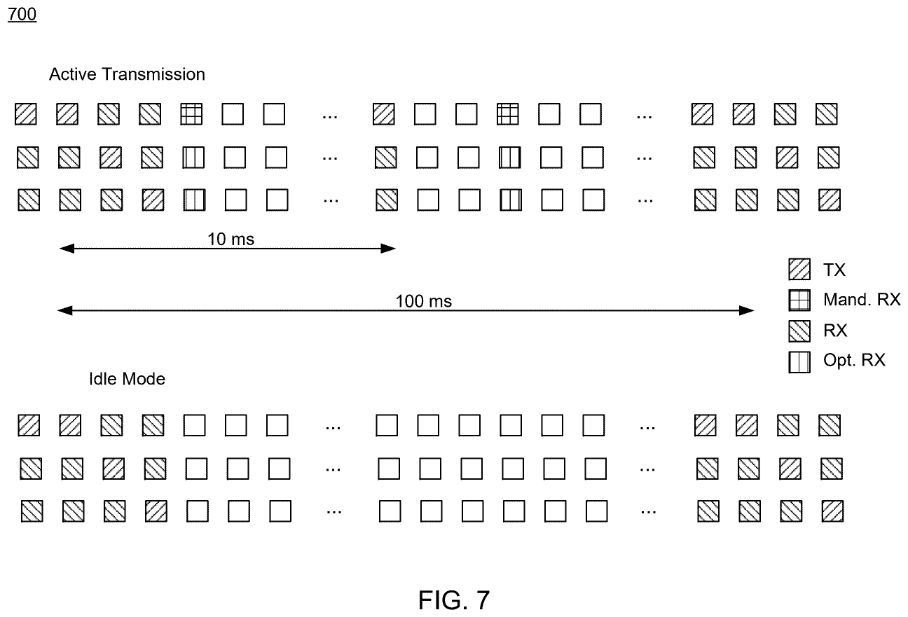

Referring now to FIG. 7, illustrated is a timing diagram 700 depicting active transmission and idle mode intervals for broadcast isochronous streams (BIS) in a group audio chat system. The timing diagram 700 can represent periodic activity exchange among devices within a broadcast isochronous group during audio streaming or subrated idle synchronization. The sequence demonstrates alternating transmit (TX), mandatory receive (Mand. RX), and optional receive (Opt. RX) cycles during an active communication state, transitioning to extended idle intervals during low activity or silence periods.

The timing diagram 700 can represent transitions between active and idle communication phases within the broadcast isochronous stream schedule for devices engaging in decentralized group audio communication. The timing diagram 700 can illustrate periodic intervals during which a primary device 504 and one or more secondary devices 506 transmit and receive data frames within defined broadcast events of a broadcast isochronous group. In some implementations, the primary device 504 may occupy the top row of the diagram 700 and can operate as the synchronization reference, while the secondary devices 506 placed on the second and third rows can operate as participants synchronized to the timing of the primary device 504. For example, during each active transmission period, the primary device 504 may broadcast audio or control packets that define timing and data availability, and the secondary devices 506 may simultaneously switch between mandatory reception intervals and optional receive periods that allow concurrent listening for other participant devices. Each column in the active portion can correspond to a discrete time interval (e.g., 10 ms) which can accommodate both transmission and reception events, forming an interleaved time-division pattern supporting bidirectional audio exchange without connection-based links.

In some implementations, the bottom portion of the timing diagram 700 can correspond to an idle mode in which the broadcast cadence transitions to a subrated timing schedule. The primary device 504 can continue transmitting periodic anchor broadcast isochronous stream packets as keepalive signals at extended intervals, such as every 100 ms, while secondary devices 506 can maintain synchronization by receiving those anchor packets to sustain timing alignment. For example, when the session enters a silence or low-activity state, the secondary devices 506 may reduce their active receiving intervals and listen to only the mandatory anchor events, conserving power while maintaining session coherence. In another example, if audio activity resumes, the primary device 504 can resume the higher-rate transmission sequence, prompting the secondary devices 506 to reenter the ten-millisecond active timing cadence. Thus, the timing diagram 700 can reflect how the periodic patterns of the primary and secondary devices coordinate active data exchange and idle synchronization states to balance low latency, channel stability, and power efficiency for the decentralized group audio session.

The primary device 504 (and/or any secondary device 506 which is serving as a backup primary device role) can transmit/communicate/broadcast a periodic advertising (PA) signal and a broadcast isochronous stream (BIS) signal. The PA signal can convey information about the presence of the BIS transmission and can operate in accordance with wireless personal area network (WPAN) broadcast behavior. The BIS signal can convey information about the status of certain channels, such as whether any channels/slots are in use for actively transmitting audio stream data and/or whether any channels/slots are available for actively transmitting audio stream data. In some implementations, both PA and BIS resources may occupy distinct portions of available airtime, and the devices 504, 506 can allocate bandwidth for both channels during broadcast intervals. For example, the primary device 504 can transmit PA frames to announce active BIS transmissions and timing information. The devices may use the announcements to identify packet counters, determine synchronization offsets, and prepare to receive subsequent BIS signals within the same scheduling window. In some implementations, the devices 504, 506 can also align the PA sequence to the timing reference of the master clock source so that multiple PAs remain temporally consistent across the broadcast isochronous group. In another example, a secondary device 506 can receive consecutive PA transmissions from nearby devices 504, 506, verify timing consistency, and update its association table before combining audio payloads from multiple sources. The PA transmission may indicate that audio content is active on the BIS stream, after which the device can synchronize its receiver to the BIS interval.

In some implementations, transmission operations within a broadcast isochronous group can proceed without temporal alignment between advertising events (ADV) and periodic advertisements (PA) relative to existing broadcast isochronous stream (BIS) transmissions/signals. Each BIS can include header information that indicates the presence or absence of active audio content. For example, when a device receives a BIS header indicating audio activity, the device can configure its receiver path and begin processing incoming packet payloads, while a BIS header indicating no audio activity can trigger entry into a reduced-duty subrated mode. In another example, the absence of specific ADV-BIS alignment requirements can simplify timing control by permitting asynchronous updates across multiple broadcast channels while maintaining consistent communication intervals.

Since each BIS can remain established during both active and idle conditions, there may be minimal additional wireless personal area network (WPAN) protocol overhead when audio transmission resumes, apart from changing a subrating parameter. When audio is indicated to be absent, all communicating devices can subrate the PA/BIS interval to a longer duration, such as 100 milliseconds, thereby conserving energy while preserving a reference cadence. The subrated BIS can serve as an anchor BIS that functions as the temporal reference for receiving keep-alive packets. For example, the periodic advertising (PA) BIG_offset field may reference this anchor BIS so that every participant device aligns its reception window to the same event, maintaining synchronization even when no active audio traffic exists. In another example, a device returning from an idle state can reacquire alignment by sampling the next anchor BIS event indicated by the PA.

When the anchor BIS indicates that audio is present, the immediate subsequent isochronous (ISOC) interval, for example ten milliseconds later, can begin carrying encoded audio data. This transition minimizes audio start-up latency because participants can reuse existing BIS timing without reinitializing link parameters. The audio path may still perform initialization of codec and buffer components, so a minimal latency overhead remains relative to persistent streaming. In some implementations, the PA message can include aggregated indicators of audio state for multiple BIS channels, allowing receiving devices to monitor a single PA signal instead of individually decoding each active BIS. For example, this aggregation can reduce monitoring bandwidth for multi-stream groups, although it can increase switching latency and introduce a potential single source dependency when PA aggregation is disrupted.

The described broadcast structure can provide scalability through multiple BIS channels operating within a single broadcast isochronous group (BIG). Each BIS can occupy interleaved transmission intervals to distribute airtime evenly across the spectrum and reduce interference between concurrent transmitters. For example, when four devices share a BIG, interleaved scheduling can position successive BIS events such that two BIS may not overlap while maintaining offsets relative to the anchor BIS. In another example, a monitoring device may use the interleaved arrangement to reconstruct a continuous group audio mix by sequentially summing received BIS payloads. The interleaved BIS arrangement therefore reuses existing WPAN broadcast architecture while supporting efficient operation of decentralized, bidirectional group audio streaming.

In some embodiments, the systems and methods described herein may be backwards compatible with devices which are audio sinks but not sources, such that the devices can receive broadcast audio transmissions while lacking active transmission functionality. In these embodiments, each broadcast isochronous stream (BIS) can share a common audio channel designation to permit unified playback across multiple receiving devices without creating channel differentiation among transmitters. For example, when several BIS sources deliver mono audio aligned to the same logical audio location, a wireless personal area network (WPAN) sink can aggregate the identical signals received from different transmitters to reconstruct a coherent mono output signal. In another example, multiple WPAN receivers can perform amplitude normalization across the concurrent BIS packets to maintain consistent sound field perception during mixed source operation.

In some implementations, when an active audio transmission is not present, the allocated broadcast isochronous stream (BIS) slot can remain mostly unoccupied except for periodic anchor BIS packets transmitted under a subrated cadence to preserve time synchronization within the broadcast isochronous group. For example, the periodic advertising (PA) sequence transmitted by the primary device 504 can continue indicating that audio is active, by broadcasting group information with empty payloads (e.g., without active audio streams from the primary device 504 or any secondary devices 506). To prevent premature timeout during a low-activity phase, the BIG_Sync_Timeout parameter may be extended to approximately 500 milliseconds so that no session reset occurs while all devices in the device group 502 operate at subrated intervals. In another example, a receiving wireless device 506 can maintain synchronization lock by referencing consecutive anchor BIS packets until regular audio packets resume without resetting its internal connection state.

In some embodiments, design parameters, including BIS payload counter values and other synchronization-related parameters, can follow WPAN specifications to maintain compatibility with legacy receiver implementations. For example, a payload counter can increment according to the same sequence and rollover behavior defined for a broadcast isochronous system. Such implementations can permit decoders on legacy devices to process transmissions from the device group 502 without firmware modification. In another example, authentication and decryption parameters used/included within the group 502 can follow the encryption and key derivation format defined for WPAN broadcasts/transmissions. According to these implementations, a WPAN sink device 506 may be configured to receive and decode audio while remaining in receive-only mode for certain environments or applications that involve a listening functionality, such as public announcement or shared media playback scenarios.

For slot scheduling, the primary device 504 can use static and/or dynamic slot assignments. The primary device 504 can establish and broadcast the scheduling policy that defines whether BIS slots are allocated statically or dynamically among the device group 502. In some implementations, the primary device 504 can select a static slot assignment policy when the number of participants is predictable and remains below a defined channel threshold (e.g., less than the number of available channels for the device group 502). Such implementations may configure time division of BIS slots, thereby preventing overlapping transmissions. For example, the primary device 504 can assign a fixed BIS index and corresponding offset to each registered secondary device 506 at session creation so that each device transmits during a dedicated channel interval and receives during other intervals. In another example, the primary device 504 can update and rebroadcast the slot configuration table whenever a new join or leave event occurs.

In some implementations, the primary device 504 can perform dynamic slot assignments in which one or more BIS slots are allocated to secondary devices 506 on an as-needed basis. In this regard, through dynamic slot assignments, the device group 502 can support a large number of participant devices by permitting active BIS usage on-demand (e.g., when the primary device 504 and/or a secondary device 506 detects a voice activity trigger and issues a slot request). For example, when the primary device 504 receives a slot allocation request together with a VOX trigger indication from a secondary device 506, the primary device 504 can assign a temporary BIS index and transmit an update in a subsequent synchronization broadcast. In another example, if multiple slot requests arrive concurrently, the primary device 504 can evaluate the timing intervals of each request and issue assignments to reduce overlap, while secondary devices 506 not receiving assignments enter a random back-off interval before re-attempting. The primary device 504 can monitor packet identifiers and collision reports to refine dynamic re-assignment and thereby balance scalability with predictable broadcast performance.

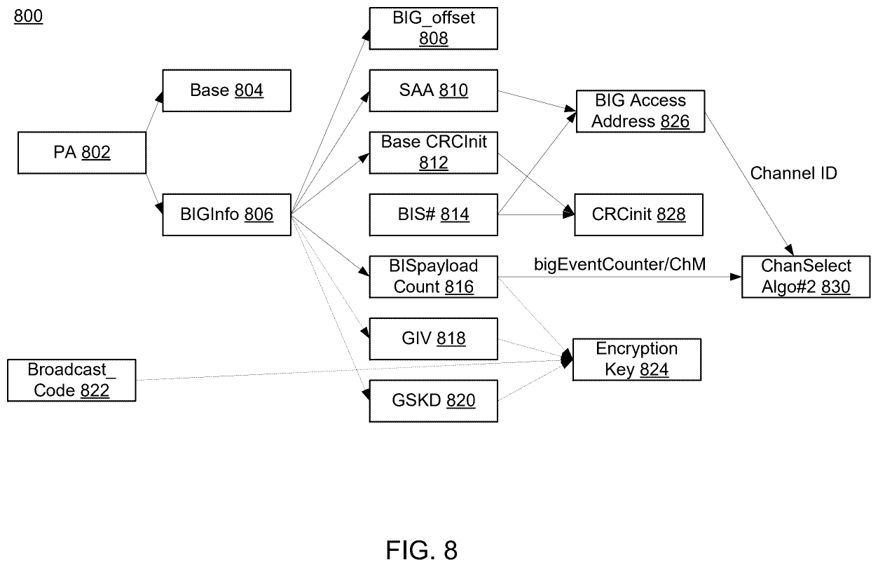

Referring now to FIG. 8, illustrated is a parameter dependency diagram 800 representing the logical dependencies among parameters used for distributed broadcast isochronous stream (BIS) management within a group audio chat environment. The diagram 800 can include periodic advertising 802, base 804, broadcast isochronous group information 806, broadcast isochronous group offset 808, stream access address 810, base cyclic redundancy check initialization 812, broadcast isochronous stream number 814, broadcast isochronous stream payload count 816, group initialization vector 818, group session key derivation 820, broadcast code 822, encryption key 824, broadcast isochronous group access address 826, cyclic redundancy check initialization 828, and channel selection algorithm 2 830.

The periodic advertising 802 can operate as a recurring broadcast signal (referred to herein as a first periodic signal) used by a primary device 504 to distribute synchronization data and participation identifiers across the device group 502. The periodic advertising 802 can include information such as a broadcast identifier, a broadcast isochronous group offset, and a session identifier that secondary devices 506 may use to determine timing alignment and join procedures. In some implementations, the periodic advertising 802 can reference the base 804 and broadcast isochronous group information 806 fields so that secondary devices 506 can determine/identify/derive frequency channels and access addresses during initial synchronization. For example, the periodic advertising 802 can signal/identify/provide auxiliary pointers identifying synchronization data within the isochronous group information 806 to reduce connection latency for a joining device. In another example, the primary device 504 may provide/transmit/broadcast the periodic advertising 802 according to a defined cadence, such as a one hundred millisecond interval aligned to anchor broadcast isochronous stream events, to sustain temporal coherence among devices in the device group 502, to mitigate slot overlap within the broadcast channel.

The base 804 (referred to herein as a second periodic signal) can define a common configuration reference for establishing timing, frequency, and packet exchange parameters that govern broadcast isochronous stream (BIS) transmissions within the group. The primary device 504 (and/or any secondary device 506 which serves as a backup primary device role) can broadcast the base 804 and PA signal 802 at a similar cadence/frequency as the PA signal 802. In some implementations, the primary device 504 can broadcast the PA signal 802 at a first frequency or cadence (e.g., 100 ms) and can broadcast the base 804 at a second frequency or cadence (e.g., 10 ms during active talk, and at 100 ms during inactive/idle mode). The base 804 can include data elements that specify channel usage, interval length, and inter-frame delays, to be used by devices to generate synchronized BIS packets. In some implementations, the base 804 can provide configuration values to the broadcast isochronous group information 806 so that all participating devices in the device group 502 share a common set of timing relationships. For example, the base 804 can be referenced simultaneously by the primary device 504 and one or more secondary devices 506 to maintain deterministic offsets for all BIS events. In another example, the base 804 may use identifiers exchanged through periodic advertising 802 to verify that each device in the device group 502 operates under a consistent structure of service data.

In some embodiments, the primary device 504 may maintain/represent a channel map within or in connection with the base 804. The channel map can represent a bitmap or table maintained as part of the base 804 to describe how individual radio channels are employed and/or used for each BIS stream. The channel map can define which data channels are active, which are temporarily excluded, and how hopping sequences are distributed among devices. In some implementations, the channel map can be transmitted by the primary device 504 through control packets (e.g., the base 804 or other dedicated signaling), which may be sent multiple times before an updated map takes effect. For example, when interference is detected on one or more channels, the primary device 504 can issue an upcoming map update that reassigns operating frequencies after a predetermined delay. By indicating an updated/upcoming channel map change ahead of time, the secondary devices 506 may be configured to retune in a synchronized manner. In another example, the secondary device(s) 506 may send a preference report reflecting local signal quality to the primary device 504. The primary device 504 may be configured to aggregate channel quality reports across the device group 502. The primary device 504 may be configured to issue a revised channel map in a subsequent control command to optimize spectral efficiency during broadcast isochronous operation.

The broadcast isochronous group information 806 can define a structured dataset used by devices in a broadcast isochronous device group 502 to establish timing, synchronization, and security context for distributed broadcast isochronous stream operation. The broadcast isochronous group information 806 can include a plurality of component parameters, such as a broadcast isochronous group offset 808, a stream access address (SAA) 810, a base cyclic redundancy check initialization (CRCInit) 812, a broadcast isochronous stream number (BIS#) 814, a broadcast isochronous stream payload count 816, a group initialization vector (GIV) 818, and a group session key derivation (GSKD) 820. In some implementations, the broadcast isochronous group information 806 can include additional or alternative fields that specify addressing, channel selection, and encryption values to enable coordinated operation among devices within a communication session. For example, the broadcast isochronous group information 806 may contain identifiers corresponding to individual streams and timing offsets that are interpreted by devices in the device group 502 to align local oscillators to a primary clock reference. In another example, the broadcast isochronous group information 806 may include information elements that define encryption input data or derivation inputs to secure broadcast payloads during session exchanges. Collectively, the parameters within the broadcast isochronous group information 806 can operate as a shared framework that describes the temporal and cryptographic attributes of a broadcast isochronous group in coordination with periodic advertising 802.

The broadcast isochronous group information 806 can include a broadcast isochronous group offset 808. The broadcast isochronous group offset 808 can define a relative timing relationship between a periodic advertising 802 anchor and the beginning of a broadcast isochronous stream transmission window. In some implementations, the broadcast isochronous group offset 808 may represent the offset value that configures each participating device to align receive or transmit activity with the broadcast isochronous group interval established by the primary device 504. For example, the broadcast isochronous group offset 808 can specify the epoch at which a secondary device 506 begins a receive window relative to the advertising anchor, such that clocks clock signals within the device group 502 remain synchronized. In another example, the broadcast isochronous group offset 808 can serve as an index into a timing table generated from parameters of the base 804, for devices in the device group 502 to calculate/determine/derive frame start times for both audio and control events within the broadcast isochronous group cycle.

In some implementations, the broadcast isochronous group offset 808 may be embedded within broadcast isochronous group information 806 as a time alignment field that is periodically transmitted over auxiliary periodic advertising or broadcast isochronous stream protocol data units. For example, each device can extract the broadcast isochronous group offset 808 from the received broadcast isochronous group information 806 and adjust a respective internal counter by applying the offset value with the timing data of the associated base 804, to determine the next receive interval. In another example, when a physical layer transition or clock source reassignment occurs, the primary device 504 may update the broadcast isochronous group offset 808 for rebroadcasting, such that the secondary devices 506 apply revised alignment values without rejoining the session. The broadcast isochronous group offset 808 can provide deterministic temporal coordination across the broadcast isochronous group and maintain collision-free operation of individual broadcast isochronous stream events.

The broadcast isochronous group information 806 can include a stream access address 810. The stream access address 810 can be, include, or otherwise represent the unique address used by devices to identify and demodulate packets belonging to a given BIS. In some implementations, the stream access address 810 can define a linkage between the BIG offset 808 and CRC initialization values 812, forming the channel selection identifier. In one implementation, the stream access address 810 may be generated from a device ID and a parent ID value propagated through the hierarchy as shown in FIG. 6. In some implementations, the stream access address 810 may be derived during BIG formation and preserved during session maintenance updates. For example, each of the devices in the devices in the device group 502 may perform/execute a channel selection algorithm based on the stream access address 810, to determine physical transmission channels.

The base cyclic redundancy check initialization 812 can define a seed value used by the primary device 504 and secondary devices 506 within the device group 502 to validate data integrity of broadcast isochronous group packets. The primary device 504 may generate the base cyclic redundancy check initialization 812 according to parameters stored in the base 804 and include the initialization value within a broadcast isochronous group information message for downstream synchronization. In some implementations, the primary device 504 can broadcast the base cyclic redundancy check initialization 812 to every secondary device 506 within the device group 502, so that each receiving transceiver can compute verification codes consistent with the broadcast isochronous group access address 826. For example, when the secondary devices 506 receive the broadcast, each secondary device 506 may combine the base cyclic redundancy check initialization 812 with its assigned stream access address 810 to calculate local error detection values for received audio or control data. In another example, when the primary device 504 transitions between active and subrated broadcast states, the base cyclic redundancy check initialization 812 may allow secondary devices 506 maintaining subrated broadcast isochronous stream timing to continue validating incoming packets without interruption. The base cyclic redundancy check initialization 812 may propagate through each individual cyclic redundancy check initialization 828 to maintain error consistency across all active and idle broadcast isochronous streams in the device group 502.

The broadcast isochronous stream number 814 can identify each broadcast isochronous stream (BIS) associated with the device group 502 and maintain a mapping between active transmission slots and corresponding frequency resources. The primary device 504 can assign a distinct broadcast isochronous stream number 814 to each secondary device 506 joining the device group 502 so that audio and control transmissions maintain deterministic time and channel separation. In some implementations, the primary device 504 can update the broadcast isochronous stream number 814 dynamically when a new secondary device 506 joins or departs the group, propagating an updated BIG information message to maintain alignment of stream indexes across all participants. For example, the primary device 504 can allocate the next available stream number 814 to a newly admitted secondary device 506 and broadcast corresponding base cyclic redundancy check initialization 812 and frequency-hop values that the secondary device 506 may use for channel selection. In another example, when a secondary device 506 completes its transmission and/or leaves the communication range, the primary device 504 can release the associated stream number 814 and rebroadcast the revised assignment table within the next synchronization interval so that other secondary devices 506 interpret the slot as available for subsequent voice-triggered usage. The broadcast isochronous stream number 814 can therefore serve as an index for identifying the state, ownership, and physical layer parameters of each BIS within the distributed BIG maintained by the device group 502.

The broadcast isochronous group information 806 can include a broadcast isochronous stream payload count 816. The broadcast isochronous stream payload count 816 can represent the counter value generated and transmitted by a primary device 504 to indicate the current sequence position of broadcast packets within a broadcast isochronous stream of a device group 502. In some implementations, each secondary device 506 can receive the broadcast isochronous stream payload count 816 from the primary device 504 during each periodic synchronization update in order to maintain consistent indexing across all active and idle broadcast streams. For example, the primary device 504 can increment the broadcast isochronous stream payload count 816 for every transmission interval and embed the updated value in a BIGInfo field so that secondary devices 506 can calculate the next radio channel using a channel selection algorithm based on the incremented count. In another example, when a handover event or a physical layer transition occurs, the primary device 504 can reset the broadcast isochronous stream payload count 816 and transmit the reset value to prevent timing drift in the device group 502. The secondary devices 506 may use the broadcast isochronous stream payload count 816 to sustain synchronization during subrated states such as a 100 millisecond idle cadence, thereby maintaining packet ordering and avoiding receiver timeout conditions even in the absence of active audio data.

The group initialization vector 818 can define an initialization value used by a primary device 504 to generate cryptographic keys that establish secure communication within a device group 502. In some implementations, the group initialization vector 818 may be distributed by the primary device 504 through periodic advertising data included in broadcast isochronous group information 806, to provide a shared cryptographic seed among all devices in the device group 502. For example, the primary device 504 can combine the group initialization vector 818 with a group session key derivation 820 and a broadcast code 822 to generate a session encryption key 824 that the devices 504, 506 derive locally for decoding broadcast audio data. In another example, when the device group 502 is reformed after an out-of-range recovery event, the primary device 504 may rotate the group initialization vector 818 and broadcast the updated value in a new session header. In this regard, each participating secondary device 506 may use a refreshed cryptographic context. The group initialization vector 818 may maintain session-specific encryption across all broadcast isochronous streams without a pairing procedure among the devices 504, 506.

The group session key derivation 820 can operate as a shared cryptographic input applied by the primary device 504 and secondary devices 506 within the device group 502 to generate common/matching/identical session encryption keys 824 for transmission of broadcast isochronous stream data. In some implementations, the primary device 504 can transmit reference parameters, such as a group initialization vector 818 and a broadcast code 822, through periodic advertisements so that each secondary device 506 can execute the same AES-based derivation process locally. For example, upon receipt of periodic synchronization information, each secondary device 506 can apply the broadcast code 822 and the group initialization vector 818 to a formula corresponding to group session key derivation 820 to obtain the matching session key used to decrypt or encrypt BIS payloads during active transmission intervals. In another example, when the primary device 504 updates the broadcast code 822 following a session reformation or handover event, each secondary device 506 within the device group 502 can recompute the group session key derivation 820 and align to the refreshed encryption context absent a connection-based pairing.

The broadcast code 822 can operate as shared keying information that the primary device 504 generates and transmits to authenticate members of the device group 502. The primary device 504 can include the broadcast code 822 within periodic synchronization data to define access control for devices joining or rejoining the broadcast session. In some implementations, one or more secondary devices 506 can derive a local copy of the broadcast code 822 from information obtained through onboarding signals, such as a session name, a QR code, or a voice input. For example, a secondary device 506 can receive an onboarding hash corresponding to a session identifier and compute a matching broadcast code 822 before joining the device group 502. In another example, the primary device 504 can use the broadcast code 822 together with a group initialization vector 818 to generate a group session key derivation 820 for encrypting/decrypting broadcast isochronous streams. The broadcast code 822 may be transmitted as an unencrypted value in open sessions, or as an encrypted value in secured sessions, to differentiate public listen-only broadcasts from protected broadcast isochronous stream sessions among authorized devices 504 and 506 participating within the device group 502.

The encryption key 824 can operate as a session-specific cryptographic key used by the primary device 504 and each secondary device 506 within the device group 502 to protect broadcast isochronous stream payloads against unauthorized decoding. In some implementations, the primary device 504 can generate the encryption key 824 from the group session key derivation 820 and the group initialization vector 818 and transmit corresponding derivation data through periodic advertising, to synchronize key computation across the device group 502. For example, once the secondary devices 506 receive the broadcast session parameters, each secondary device 506 can apply a common derivation process to obtain a matching encryption key 824 that decrypts incoming audio packets. In another example, when control transitions occur, such as a transfer of primary clock authority from the primary device 504 to a secondary device 506, the secondary device 506 (now acting as or assuming primary device responsibilities) can generate a new encryption key 824 and broadcast the new encryption key 824 within the next synchronization interval. In some embodiments, the encryption key 824 may be stored within local memory structures of the primary device 504 and secondary devices 506 during the active session, and the encryption key 824 can be erased/purged/rotated following session termination or reformation.

The broadcast isochronous group access address 826 can operate as a unique identifier maintained by a primary device 504 for broadcast isochronous streams associated with a device group 502. The primary device 504 may generate the broadcast isochronous group access address 826 when establishing a broadcast isochronous group and transmit the identifier within periodic advertisements to secondary devices 506. In some implementations, the secondary devices 506 can receive and store the broadcast isochronous group access address 826 to align radio operation parameters with those of the primary device 504. For example, a secondary device 506 can apply the broadcast isochronous group access address 826 together with a cyclic redundancy check initialization 828 and a broadcast isochronous stream payload count 816 to calculate channel identifiers through a channel selection algorithm 830, to maintain channel synchronization across the device group 502. In another example, when a session update or reformation occurs, the broadcast isochronous group access address 826 may remain persistent so that secondary devices 506 retain their ability to decode transmissions without performing a full rejoin sequence.

The cyclic redundancy check initialization 828 can operate as an individual seed value used by the primary device 504 and one or more secondary devices 506 within the device group 502 to calculate cyclic redundancy check (CRC) values for verifying packet integrity within each broadcast isochronous stream. In some implementations, the primary device 504 may generate the cyclic redundancy check initialization 828 as a function of the base cyclic redundancy check initialization 812 and the broadcast isochronous stream number 814 before transmitting it as part of the broadcast isochronous group information. For example, the primary device 504 can compute a distinct seed value for each broadcast isochronous stream and distribute the computed value to the secondary devices 506 so that each device in the device group 502 applies a matching error verification code to received audio and control packets. In another example, a secondary device 506 can track missing packets or detect mismatched CRC results. The secondary device 506 can use the identified missing packets/mismatched CRC results to identify slot conflicts or potential transmission errors during dynamic slot reassignment. When a broadcast isochronous stream is repurposed for a new transmitter, the primary device 504 may reinitialize the cyclic redundancy check initialization 828 by generating a new seed and broadcasting the new seed in a subsequent synchronization message. Such implementations may configure each of the secondary devices 506 in the device group 502 to maintain valid packet authentication and consistent error-detection parameters across the session.

The parameter dependency diagram 800 can include a channel selection algorithm 830. The channel selection algorithm 830 can define a computational process that determines an RF carrier channel index for each packet within a broadcast isochronous group. In some implementations, the channel selection algorithm 830 can correspond to channel selection algorithm 2 as defined by WPAN protocol specifications. The channel selection algorithm 830 can operate using inputs, such as the BIG access address 826 and the broadcast isochronous stream payload count 816. For example, each increment of the broadcast isochronous stream payload count 816 can result in selection of a different carrier frequency from a channel map. In another example, the channel selection algorithm 830 can run on device controllers (e.g., of the primary and secondary devices 504, 506) which parse the BIGInfo fields and retrieve the values of the BIG access address 826 and other timing parameters to compute successive channel indices. The channel selection algorithm 830 may further apply updates issued through channel map change commands transmitted by the primary device 504 using control PDUs, so that subsequent channel computations reflect the revised frequency allocation within the broadcast isochronous group.

Devices can use a protocol for joining the session by scanning and detecting periodic advertisements transmitted within the device group 502. The primary device 504 can initiate these advertisements by transmitting one or more primary and secondary advertising packets, such as ADV_EXT_IND, AUX_ADV_IND, and AUX_SYNC_IND, to announce creation of a broadcast isochronous group. When a secondary device 506 receives an advertising packet referencing an active session, the secondary device 506 may transmit a join notification within a free anchor broadcast isochronous stream (BIS) slot. In some implementations, the join notification can include a unique identifier of a secondary device 506, synchronization intent, and authentication information derived from one of the onboarding methods described herein. For example, the secondary device 506 can broadcast a short control packet referencing the BIGoffset and BISpayloadcount provided by the primary device 504 to request inclusion in the synchronized session. The primary device 504 can then incorporate this new participant into the device group 502 by allocating a slot or updating the synchronization parameters transmitted in subsequent advertisements.

Once joined, a secondary device 506 may periodically transmit keepalive or health status information to maintain consistency within the device group 502. In some implementations, the primary device 504 and a designated secondary device 506 may alternate short synchronization beacons at approximately one hundred millisecond intervals, while other secondary devices 506 can report status at longer or randomized intervals to reduce collision probability. When a device ceases/foregoes broadcasting health information for a defined interval, the primary device 504 can identify the secondary device 506 as inactive and update the group table accordingly. For example, the primary device 504 can remove the inactive entry and release its previously assigned slot number for reassignment. In another example, a secondary device 506 intending to disconnect voluntarily may transmit a leave command within a BIS anchor interval, allowing the primary device 504 to confirm session closure. The session may remain active as long as at least two devices are present within the communication boundary. Where fewer than two devices (e.g., one device) are active, the primary device 504 may terminate all advertisements and close the broadcast isochronous group after a timeout period.

To join, a device can use one or more schemes to initiate a request to participate in the device group 502. The primary device 504 can broadcast session information that secondary devices 506 use to obtain identifiers, timing references, and encryption codes required for onboarding. In some implementations, onboarding can occur through physical association using PA synchronization transfer (PAST), through a machine-readable medium such as a QR code or URL, user inputs provided via selectable elements on the device, and/or through an audio-based command referred to as a voiced code. For example, the secondary device 506 can acquire information through any of these methods and then transmit a join message/notification/request including identification data and synchronization intent to be acknowledged by the primary device 504. Each of these joining techniques can permit decentralized admission without establishing pairing connections.

In some implementations, PAST can provide direct transfer of session parameters between devices. The primary device 504 can transmit a PA sync transfer (PAST) message including the broadcast name, broadcast identifier (BID), session identifier (SID), and broadcast code values used to align the joining secondary device 506 with the active broadcast isochronous group. For example, when a user operates a phone as the initiating device, the phone can generate the necessary connection metadata and send the information wirelessly to a head-worn secondary device 506 to complete onboarding. The PAST procedure may include additional fields in addition to those for PA sync transfer, such as to describe further parameters for the decentralized broadcast session, rank assignment, and/or or initial clock offset relative to the primary device 504.

In some implementations, the joining operation can make use of a QR code or a URL (or other unique resource identifier) that encodes the same session data provided during PAST. The primary device 504 or an associated user interface can present/render/provide a resource identifier which includes/encodes/contains the broadcast name, broadcast identifier, session identifier, and broadcast code (if encryption is applied). For example, the secondary device 506, such as a pair of glasses, can scan the displayed resource identifier to retrieve session parameters, and generate internal synchronization tables before sending a join signal within a free anchor BIS slot to the primary device 504. In another example, a uniform resource locator (URL) received from an electronic message or link can include/encode/link to relevant or corresponding onboarding data that the secondary device 506 identifies for use when initiating a join procedure within the device group 502.

In some implementations, onboarding can be provided through user inputs via selectable elements (e.g., buttons, keys, or user interface elements) on the device a voiced code (e.g., a voice-derived identifier) that allows a user to create or join a session by speech input. The primary device 504 can receive a keyword/passcode/spoken session name from an initiating user. In implementations in which the primary device 504 receives a keyword, passcode, or other user inputs through onboarding, the primary device 504 can compare the received user inputs to the configured/established key for onboarding, and permit/deny access to the group session based on whether the inputs match the key. In implementations in which the onboarding is provided via the voice-derived identifier, the primary device 504 can apply a hash function to the spoken session name, to translate the name into a session identifier, broadcast identifier, broadcast name, and broadcast code for the device group 502. For example, when the initiating user states a command declaring creation of a session name, the primary device 504 can generate a hash value that other secondary devices 506 can reproduce locally when users repeat the same phrase. In another example, a user can issue a join command verbally, and the secondary device 506 can compare the derived hash to the broadcast identifier transmitted by the primary device 504 before sending a join notification. The spoken session name therefore operates as a shared credential that allows entry into the session without disclosing reversible session information in the open broadcast.

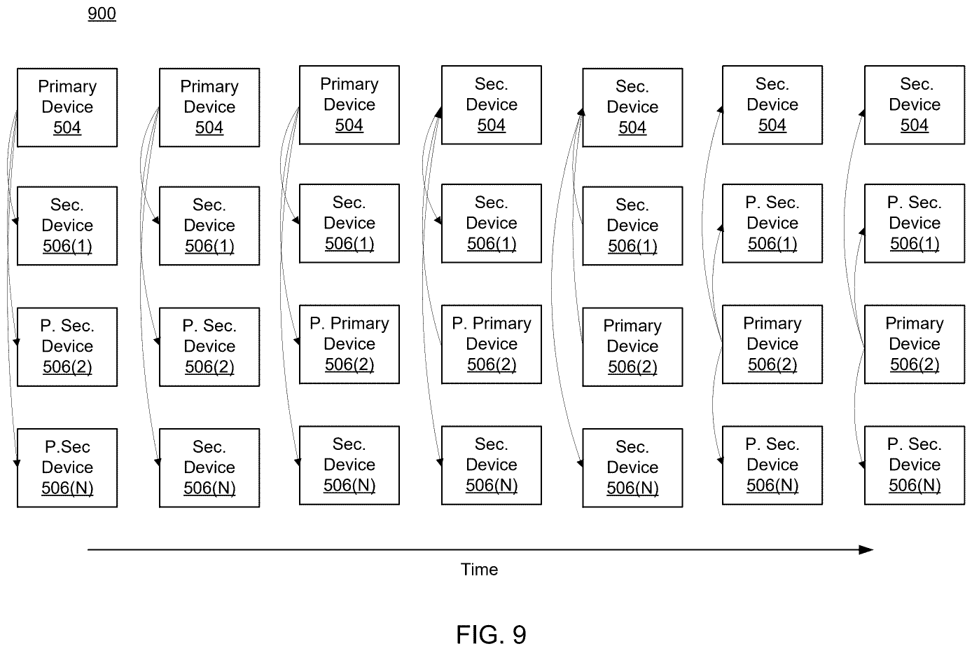

Referring now to FIG. 9, illustrated is a diagram 900 representing a hierarchical flow of device role succession that occurs over time within a decentralized group audio communication session. The diagram 900 can include a primary device 504 and one or more secondary devices 506(1)-506(N), depicting transitions of timing control and synchronization responsibilities among devices within a broadcast isochronous group. The temporal sequence shown in the figure demonstrates how primary, prospective primary, and secondary roles change dynamically as each device transmits or ceases to transmit audio during the session (or otherwise enter and exit the device group 502), thereby maintaining continuous synchronization among all devices.

The primary device 504 can maintain reliability of timing control within the device group 502 by designating one of the secondary devices 506 as a backup primary source of the clock reference. In some embodiments, a secondary device 506 may operate as a back-up primary device, in synchronized alignment with the primary device 504, so that the internal clock of the secondary device 506 can serve as a valid timing reference for other devices in the device group 502 when the primary device 504 becomes unavailable or moves out of range. For example, when the secondary device 506 detects a loss of synchronization signals from the primary device 504, it can monitor neighboring broadcast isochronous slots to determine whether other devices 506 also indicate loss of the primary clock source. Where the loss of primary clock source is indicated/identified for the device group 502, the secondary device 506 can assume the primary role and begin broadcasting updated synchronization information to the device group 502. In another example, when the secondary device 506 does not receive multiple indications of loss from other members, the secondary device 506 can determine that the lack of receptions/indication of loss is indicative of a localized range issue and temporarily suspend its backup primary role until valid reception resumes.

The system may be fully, partially decentralized, or fully centralized, depending on the structure and operational control of participating devices of the device group 502 within the broadcast isochronous group. Each configuration can define a distinct hierarchy of timing and coordination that balances power consumption, fault tolerance, and control effort among the participating devices. In a fully centralized arrangement, one device, such as the initiator or primary device 504, can maintain control over the timing, slot assignment, and state management. A partially decentralized or hybrid structure can separate the clocking responsibilities from resource allocation or data aggregation, so that multiple devices can maintain independent yet synchronously aligned communication without a single control node (such as the primary device 504) controlling every operational parameter. These configurations can be selected dynamically, for example, according to device class, power source, or mission context to maintain performance within a given communication range.

In a fully centralized configuration, the primary device 504 can maintain primary control of all aspects of the group audio session, including clocking, slot assignment, and admission control. In some implementations, the primary device 504 can operate as a hub that anchors deterministic transmission intervals and coordinates participation of each secondary device 506 in the device group 502. For example, when multiple secondary devices 506 transmit within the same broadcast isochronous group, each device 506 can operate within pre-assigned time intervals provided by a centralized allocation table managed by the primary device 504. In another example, the primary device 504 can collect utilization feedback from each secondary device 506 and use the utilization feedback to regulate concurrent transmissions. The fully centralized deployment may be implemented in various environments, such as where the primary device 504 is a stationary or wall-powered device that can sustain higher computational and timing control demands during continuous group sessions.

In a partially decentralized configuration, the initiator or primary device 504 can provide the timing reference, while secondary device(s) 506 in the device group 502 can execute/control slot selection and control messaging. In some implementations, the primary device 504 can periodically broadcast synchronization data that defines the clock reference and available slots within a broadcast isochronous group, while the secondary devices 506 can select unused slots for transmission based on active voice detection or local feedback. For example, the primary device 504 can assign a secondary device 506 as a backup clock source to maintain timing continuity in case of a lapse in primary transmission. In another example, after synchronizing to the group clock, a secondary device 506 can initiate transmission events at self-selected intervals without requiring an allocation confirmation from the primary device 504.

In a fully decentralized configuration, each active transmitting secondary device 506 can assume the role of a primary clock source for the duration of its broadcast, while former primary or secondary devices 504, 506 revert to secondary or idle states. The timing hierarchy within the device group 502 can update dynamically in response to detected voice activity or transmission initiation events. In some implementations, when a secondary device 506 begins transmitting audio after acquiring synchronization from an existing primary device 504, the secondary device 506 can declare itself as a prospective master within the next broadcast interval. For example, the previous primary 504 can then transition to a backup or secondary role, while other devices 506 in the device group 502 can adjust their timing alignment to the new master. In another example, if the current primary device 504 is executing various control functions for the device group, such as channel map negotiation or PHY switching, the current primary device 504 can temporarily delay relinquishing control until completing such control functions.

Referring specifically to FIG. 9, the diagram 900 can depict this role transition over time, where each column represents a successive time instance within the ongoing group session. At an initial time instance, the primary device 504 can act as the primary device, and secondary devices 506(1)-506(N) can operate as synchronous followers within the device group 502. At a subsequent instance, when the secondary device 506(1) detects transmission stability and confirms lock to the primary clock, the secondary device 506(1) can designate itself as a prospective primary, indicated in FIG. 9 as a “P. Primary Device.” For example, after the transition, the secondary device 506(1) can begin broadcasting synchronization signals, while the previous primary device 504 assumes a secondary timing role. In another example, as time progresses, secondary device 506(2) or another active device may subsequently take on the prospective primary role, forming a continuous rotation of timing authority across time columns represented in the diagram 900.

Over additional time intervals shown in FIG. 9, each column can reflect changes in device hierarchy as new transmissions begin and others conclude. For instance, when a transmitting secondary device 506(N) enters a silent state, it can revert to a peripheral role and restore synchronization to the current master. The remaining devices 504, 506 can then update their hierarchy tables to reflect the new master-secondary arrangement. In subsequent time intervals represented by the fourth through sixth columns, the hierarchy can further evolve as the primary device 504 relinquishes its primary role and transfers timing authority to a secondary device 506(2). In some implementations, the secondary device 506(2) may assume full primary responsibilities by maintaining clock reference accuracy and periodically transmitting synchronization data to the other devices in the device group 502. For example, following the transition, the secondary device 506(2) can begin generating and broadcasting the advertising signal in place of the original primary device 504 for subsequent time instances, causing the remaining secondary devices 506(1) and 506(N) (including the previous primary device 504, now in a secondary role) to align their local clocks and slot allocations to the new broadcast reference. In another example, when the secondary device 506(2) becomes the current primary, the prior primary device 504 may continue to act as a secondary node for redundancy and timing validation.

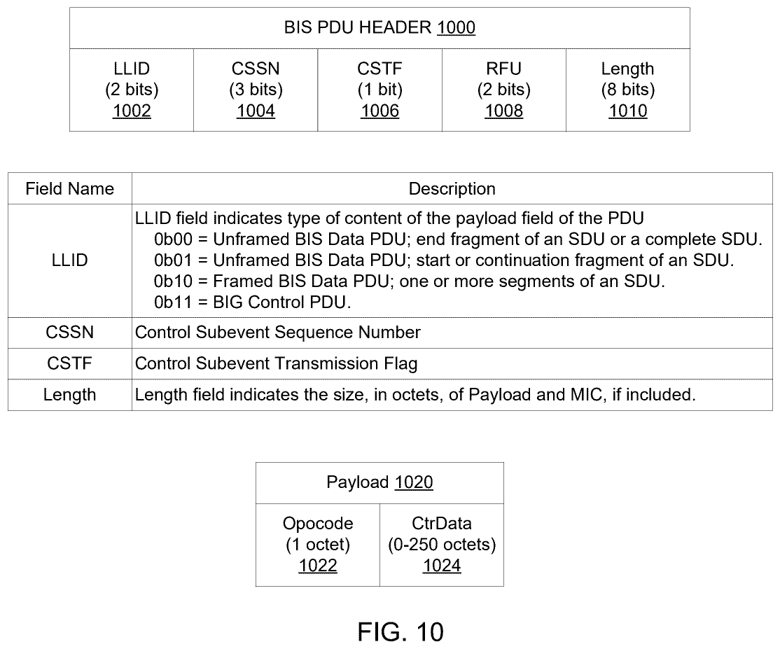

Referring now to FIG. 10, illustrated is a schematic diagram 1000 depicting the broadcast isochronous stream (BIS) protocol data unit (PDU) header structure and payload fields used in a decentralized group audio communication system. The diagram 1000 can include a logical link identifier (LLID) 1002, a control subevent sequence number (CSSN) 1004, a control subevent transmission flag (CSTF) 1006, reserved fields (RFU) 1008, a length field 1010, and a payload 1020. The payload 1020 can further include an opcode 1022 and control data 1024.

The logical link identifier 1002 can operate as a discriminating field within the broadcast isochronous stream protocol data unit header that identifies the type of information included in each packet transmitted among the devices of the device group 502. The primary device 504 can generate the logical link identifier 1002 to mark whether the associated packet conveys control signaling or audio content before transmitting the packet to the secondary devices 506. Each secondary device 506 can read the logical link identifier 1002 upon reception to determine whether to process the subsequent payload as an unframed broadcast isochronous stream data segment or as a broadcast isochronous group control message defining synchronization or configuration changes. In some implementations, the logical link identifier 1002 can occupy two bits in the header and can encode distinct values to denote packet boundaries or specific message categories, such as start or completion of an isochronous service data unit. For example, and as shown in FIG. 10, 0b00 and 0b01 encodings can be reserved for unframed audio packets, while the 0b10 and 0b11 encodings can be used for framed audio or control packets that convey synchronization, slot allocation, or status updates within the broadcast isochronous group. Each device in the device group 502 can use the logical link identifier 1002 to apply appropriate decoding routines, thereby maintaining synchronized interpretation of mixed audio and control transmissions within the shared broadcast isochronous group.

The control subevent sequence number 1004 can define a counter value used by the devices in the device group 502 to maintain ordered tracking of control protocol data units within a broadcast isochronous stream sequence. The primary device 504 can generate and increment the control subevent sequence number 1004 for every transmitted control subevent, which provides a sequential reference that secondary devices 506 can use to determine message continuity during broadcast operation. In some implementations, each secondary device 506 can compare the received control subevent sequence number 1004 to a stored value to confirm that a new control instruction or timing update is current and not a retransmission of a previous message. For example, when the primary device 504 increments the control subevent sequence number 1004 during a timing handoff or a channel allocation update, each secondary device 506 can record the new counter and identify any missing increments as a potential indicator of a lost or out-of-order control packet. In another example, a backup secondary device 506 acting as a fallback primary device can monitor successive values of the control subevent sequence number 1004 to verify synchronization freshness before resuming broadcast control.

The control subevent transmission flag 1006 can operate as a designated indicator used by devices within the device group 502 to identify whether a control subevent occurs in a given broadcast isochronous stream interval. The primary device 504 can set the control subevent transmission flag 1006 when a control packet is appended to a data PDU, thereby signaling to secondary devices 506 that both control and audio information are transmitted within the same interval. In some implementations, the primary device 504 or a transmitting secondary device 506 may toggle the control subevent transmission flag 1006 to a binary state representing the inclusion or omission of control subevent data within the broadcast frame. For example, when the control subevent transmission flag 1006 is set to a logic high state (e.g., “1”), the receiving secondary devices 506 can process the associated BIS stream as a mixed packet containing both control and audio payloads. In another example, when the control subevent transmission flag 1006 is left unset (or set to a logic low state, or “0”), the receiving secondary devices 506 can disregard control parsing operations and treat the BIS stream as containing only audio information.

The reserved field 1008 can operate as a defined bit portion of the broadcast isochronous stream (BIS) protocol data unit header that primary device 504 and secondary devices 506 in the device group 502 can reference for protocol compatibility validation. The reserved field 1008 can be maintained as an inactive segment during certain transmissions and can occupy two bits positioned between the control subevent transmission flag field and the length field of the header. In some implementations, the primary device 504 can initialize the reserved field 1008 to a fixed logic value of zero prior to broadcast, and the secondary devices 506 can monitor the field for deviations that indicate potential feature extensions. For example, the reserved field 1008 can later encode optional indicators associated with physical (PHY) layer parameters or antenna diversity selection values when a revised implementation expands BIS header capability. In another example, firmware logic on the primary device 504 can parse/inspect/analyze the reserved field 1008 on reception of loopback packets to confirm certain constraints/configurations (e.g., bit-stream alignment constraints) within the device group 502.

The length field 1010 can operate as a numerical indicator that the primary device 504 and secondary devices 506 use to define the total number of octets contained in the payload (or header and payload), for message integrity checks of a broadcast isochronous stream (BIS) protocol data unit. In some implementations, the primary device 504 may generate the length field 1010 as an eight-bit integer reflecting the measured size of audio or control data appended to the BIS header during packet assembly. For example, when transmitting compressed low-latency LC3 audio frames, the primary device 504 can encode a smaller value in the length field 1010 to indicate reduced packet size while maintaining reserved spacing for embedded control segments. In another example, the secondary devices 506 can read the length field 1010 following the reserved field 1008 to allocate an appropriate receive buffer and initiate decryption or error-checking pipelines before decoding the payload. Each device in the device group 502 may evaluate the length field 1010 to identify the presence of control subfields within a given frame and adjust its internal decoding sequence to distinguish between audio and control data portions.

The payload 1020 can operate as the data field through which the primary device 504 and secondary devices 506 exchange broadcast isochronous stream information during a group session. The primary device 504 can generate payload 1020 content containing encoded audio segments and/or control information according to the logical link identifier 1002. In some implementations, the secondary devices 506 can transmit payload 1020 frames that include voice data, network state reports, or clock offset values determined from their local timing references. For example, during an active conversation, the primary device 504 may transmit payload 1020 frames carrying synchronization updates while the secondary devices 506 concurrently transmit payload 1020 frames with voice packets in their assigned broadcast isochronous stream slots. In another example, when the system enters idle conditions, the devices within the device group 502 can exchange control payloads 1020 that convey slot status, rank identifiers, and timing coefficients to maintain continuity of the broadcast structure.

The payload 1020 may include or contain opcode 1022 and control data 1024 fields for operational execution. The primary device 504 and the secondary devices 506 can exchange the opcode 1022 and control data 1024 through encapsulated frames as part of broadcast isochronous stream communication within the device group 502. These fields can define the type of operation and the associated parameters that govern packet-level coordination among devices participating in the group. In some implementations, the primary device 504 may generate the opcode 1022 to indicate a control command and include the control data 1024 carrying identifiers and timing values relevant to the command. In another example, the secondary devices 506 may detect and parse the opcode 1022 within received frames to execute local actions such as synchronization adjustments or slot reservation updates.

For example, the primary device 504 or the secondary devices 506 can decode the payload 1020 headers to identify command sequences associated with slot assignment, channel map updates, or leave/join notifications. Each decoded opcode 1022 can provide a state transition trigger, while the control data 1024 can include fields for device identifiers, time offsets, and hierarchical rank values used to update local tables within the device group 502. In one example, the primary device 504 may issue an opcode 1022 that allocates a new slot for a joining device, and the corresponding secondary device 506 can read the control data 1024 to acquire its new broadcast isochronous stream assignment. In another example, the secondary devices 506 can generate responses using predefined opcode 1022 values and associated control data 1024 to acknowledge updated system status or to report slot utilization back to the primary device 504.

The payload 1020 can include the opcode 1022 and the control data 1024. The opcode 1022 can define the instruction type of each control protocol data unit transmitted within the broadcast isochronous group of the device group 502. The primary device 504 can generate the opcode 1022 to mark discrete command categories, such as join, leave, start, or relinquish master role, and can embed the opcode 1022 within the broadcast frame header to convey a specific operational directive. In some implementations, the secondary devices 506 can receive the opcode 1022 and determine corresponding state transitions or system responses according to command priority. For example, when the primary device 504 transmits an opcode 1022 for a “start” command, the secondary devices 506 can activate audio streaming pipelines, whereas an “end” opcode 1022 can signal deactivation of a current slot. In another example, a secondary device 506 can issue an opcode 1022 for a “join” command to request entry into the device group 502, to which the primary device 504 can respond with an updated synchronization broadcast reflecting the new inclusion. Each opcode 1022 can occupy one octet in the payload 1020 and can be parsed by firmware routines to distinguish between control and data messages, ensuring coherent execution of signaling sequences during live group communication.

The control data 1024 can represent the information field associated with the opcode 1022 and can convey the parameters that define timing, hierarchy, or status relationships among the devices of the device group 502. The primary device 504 can populate the control data 1024 with identifiers, hierarchical ranks, timing offsets, or channel map information to maintain proper synchronization and resource allocation. In some implementations, the secondary devices 506 can transmit control data 1024 containing feedback on received packets, slot utilization, and detection of missing master or backup clock sources. For example, a secondary device 506 can broadcast control data 1024 parameters that identify the clock hierarchy from which it derives timing correction, allowing other devices to update synchronization references in real time. In another example, the primary device 504 can transmit control data 1024 to announce assignment of new broadcast isochronous stream slots, including updated offsets and stream numbers that other devices of the device group 502 can apply for subsequent transmissions.

The control messaging between devices in the device group 502 can define exchange of operational commands and coordination among the primary device 504 and secondary devices 506. The primary device 504 can transmit control packets that communicate system-level instructions/configurations, such as channel map changes for the BIG, BIG termination signals, or instructions for clock and role management. In some implementations, the primary device 504 and secondary devices 506 can each issue timing control packets that include configurations/information, such as device ID, hierarchical rank, slot index, and clock offset values to configure the broadcast hierarchy. For example, the primary device 504 can periodically send timing control PDUs to distribute updated slot numbers and synchronization data, while secondary devices 506 can respond with acknowledgment packets or feedback indicating stream utilization. In another example, when the primary device 504 temporarily yields the primary role (e.g., during a user event, such as receipt of a phone call), the primary device 504 can broadcast a relinquish role command allowing another device 506 to assume clock control until the original primary device 504 returns to service.

The device group 502 can execute/configure/transmit/exchange additional reporting messages to maintain situational awareness and operational stability during ongoing group activity. The secondary devices 506 can periodically transmit feedback packets indicating slot occupancy, packet receipt, and/or the status of detected primary or backup primary device(s) 504, 506, to indicate or identify missing clock references or transmission collisions. In some implementations, the secondary devices 506 can broadcast status messages at randomized intervals to reduce collision probability while still allowing the primary device 504 to collect enough information to detect persistent coverage gaps or range issues. For example, when a secondary device 506 detects that the primary or backup primary signal has been absent for several anchor intervals, the secondary device 506 can broadcast a missing-primary report to trigger a recovery procedure within the device group 502. In another example, each device 506 can transmit a four-bit indication representing the identity of the last transmitting device on each slot, allowing other devices to map slot usage and avoid collisions. The primary device 504 may monitor such broadcast reports to adjust slot allocations, while individual devices 506 can verify availability of a slot before initiating voice activity transmission (e.g., on the slot). During ongoing audio streams, each device can defer status transmissions until intermittent anchor points or silence periods, so that the feedback process does not interrupt active audio delivery across the device group 502.

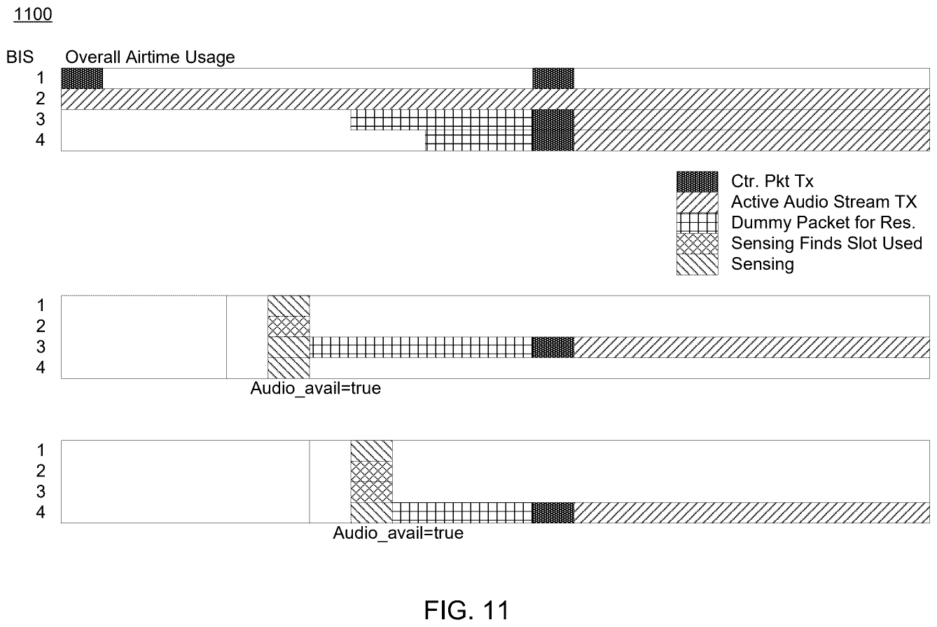

Referring now to FIG. 11, illustrated is a diagram 1100 showing overall airtime usage for broadcast isochronous stream (BIS) slots during distributed group audio streaming. The diagram 1100 can depict slot occupation across multiple BIS identifiers, illustrating control packet transmission, audio packet transmission, and sensing intervals during a broadcast session. In particular, FIG. 11 indicates how each slot transitions between active audio modes and dummy or sensing states, for an overall airtime usage (e.g., representing the temporal distribution of transmission and reception periods across broadcast isochronous streams during active and idle phases of a group audio communication session).

In FIG. 11, illustrated is time-division allocation of broadcast isochronous stream (BIS) slots used during group audio transmission. The primary device 504 and secondary devices 506 can operate according to periodic intervals in which short bursts of active audio occupy designated BIS slots, while intervening gaps can contain dummy packets or sensing operations to preserve temporal synchronization.

Each participant device within the broadcast isochronous group (BIG) can monitor real-time slot conditions and modify transmission timing to maintain coordination with the aggregate pattern illustrated in FIG. 11. In some implementations, a secondary device 506 can sense channel activity before each broadcast interval to identify occupied slots and adjust its offset index until an idle slot is confirmed. For example, the secondary device 506 can detect the presence of identifiers of other transmitters embedded in control messages and defer its own audio packet until the next available interval, preventing overlap. In another example, the secondary device 506 may continue to transmit dummy packets during brief silence to retain slot ownership while audio detection processing remains active. The reserved slots of the primary device 504 and any backup secondary device 506 can remain dedicated to control signaling, so other nodes refrain from using those anchors for audio transmission, thereby sustaining synchronized control distribution and collision-free operation across the device group 502.

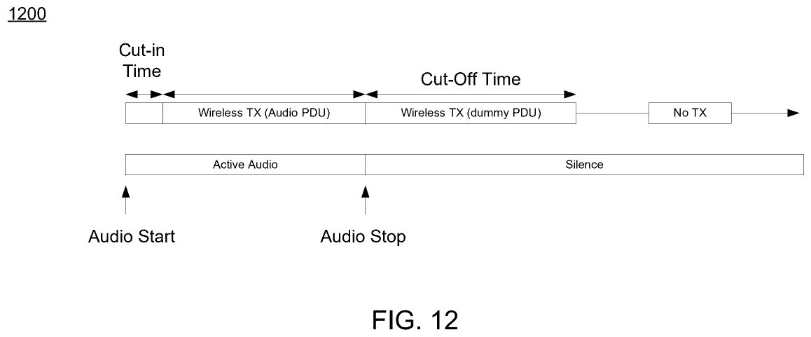

Referring now to FIG. 12, illustrated is a timing diagram 1200 showing the temporal relationship between active audio transmission, silence, and wireless transmission intervals for a device operating within a broadcast isochronous group session. The timing diagram 1200 can depict transitions that occur when a voice activity detection event triggers transmission of an audio PDU, followed by a period of dummy PDU transmissions, and finally a no-transmission state as the system enters a prolonged silence period. The timing diagram shows cut-in and cut-off times corresponding to device response latency and channel reservation retention thresholds that maintain predictable operation of voice-activated broadcast isochronous systems.

In FIG. 12, the timing diagram 1200 illustrates sequential transmission states that occur when a secondary device 506 (or primary device 504) detects speech activity on a broadcast isochronous stream (BIS). The secondary device 506 can begin a sequence with an audio start indicator generated from a sensed audio input from an onboard sensor, which triggers wireless transmission of audio protocol data units (PDUs). The secondary device 506 can continue with a period of transmitting dummy PDUs to maintain slot occupancy and conclude with a transition to a no-transmit state after a defined cut-off timer expires. In some implementations, firmware on the secondary device 506 can execute the transition between these states according to real-time voice activity detection (VAD) logic. For example, when the secondary device 506 detects speech onset, the secondary device 506 can activate its transmit path and send successive audio frames at approximately 10 millisecond intervals while maintaining radio alignment to the primary device 504 clock. In another example, once the secondary device 506 detects a pause in speech input, the secondary device 506 can continue transmitting empty BIS frames as dummy PDUs for a retention period of up to 2 seconds, allowing other devices in the device group 502 to maintain synchronization and slot reservation before the secondary device 506 transitions to an idle state.

The timing diagram 1200 also depicts how the device group 502 coordinates channel usage and resolves collisions during concurrent transmissions. In some implementations, multiple secondary devices 506 may simultaneously sense the same BIS slot or operate under hidden-node conditions, producing overlapping transmissions. For example, when concurrent transmissions prevent the primary device 504 from receiving an acknowledgment of a secondary device 506 identifier in control protocol data units, the secondary device 506 can infer contention on the slot. The secondary device 506 can then execute a randomized back-off algorithm that shifts its next transmission attempt by one or more slot intervals and initiates a new channel-sensing cycle. In another example, when the secondary device 506 detects continuous silence for longer than a defined cut-off period, such as 2 seconds, the secondary device 506 can release the reserved slot and clear its allocation flag in its local memory tables.

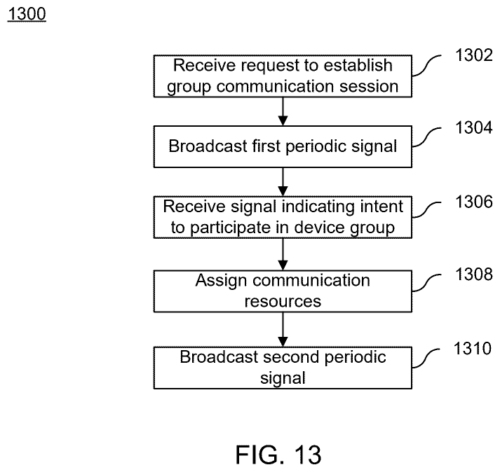

Referring now to FIG. 13, illustrated is a flowchart of a method 1300 for establishing and managing a group communication session. The method 1300 can be executed, performed, or otherwise carried out by any of the computing systems or wireless devices described herein, such as the primary device 504. In brief overview of the method 1300, the method 1300 can include receiving a request to establish a group communication session (step 1302), broadcasting a first periodic signal (step 1304), receiving a signal indicating an intent to participate a device group (step 1306), assigning communication resources (step 1308), and broadcasting a second periodic signal (step 1310).

The method 1300 can include receiving a request to establish a group communication session (step 1302). The primary device 504 can receive the request from an initiating user device or an internal application process that initiates formation of a new broadcast isochronous group. The primary device 504 can process the received request to allocate initial session parameters including a session identifier, a clock hierarchy definition, and available broadcast isochronous stream (BIS) resources that are to be advertised to prospective/potential secondary devices 506. In some implementations, the primary device 504 can generate a session creation message internally and store a corresponding identifier of the new broadcast isochronous group (BIG) in local memory before transmitting any synchronization data. For example, when a user activates a group audio mode on a wearable computing device, the primary device 504 can generate a creation packet specifying its role as the initiator and define the broadcast parameters that are to control/configure/govern subsequent transmissions.

The primary device 504 can receive a request to establish a group communication session through various predefined or user selected configurations. In some implementations, the primary device 504 can launch the application automatically and generate the request when a user initiates a group audio session control displayed on a graphical interface. For example, activation of a selectable control or icon within an on-screen session management panel can trigger a software process that generates an initialization signal to create the group session. In some implementations, the primary device 504 can receive the request automatically based on location information indicating that the device 504 has entered a predetermined geographic region associated with high ambient noise or other preset environmental conditions. For example, when the primary device 504 detects that its geographic coordinates correspond to a location classified as a concert venue, a restaurant, or a common room, the primary device 504 can initiate automatic setup of the group session using parameters stored in user-defined configuration data. In another example, the primary device 504 can identify that a user has pre-scheduled a group communication session for a defined venue/geographic location. The primary device 504 can detect/determine that the device 504 is located/positioned within the location boundary (e.g., based on a comparison of coordinates from the defined venue/geographic location and current coordinates from an onboard positioning sensor). Upon detecting that the primary device is positioned within that location boundary, the primary device 504 can commence automatic establishment of the session without additional user input.

After receiving the request, the primary device 504 can perform an initialization operation to prepare synchronization and advertisement data structures for the session. The primary device 504 can assign an initial BIG identifier, create payload field templates for the synchronization broadcast, and populate preliminary data such as a broadcast name, a broadcast identifier (BID), a session identifier (SID), and one or more broadcast codes that are to be inserted in the first periodic advertising (PA) sequence. In some implementations, the primary device 504 can verify availability of timing resources and memory buffers for broadcast management before broadcasting synchronization information. For example, the primary device 504 can wait for confirmation that internal transceiver calibration and clock reference initialization have completed before scheduling the first synchronization interval.

The method 1300 can include broadcasting a first periodic signal (step 1304). The primary device 504 can broadcast a first periodic signal to initiate or maintain the group communication session. The first periodic signal may be or include the PA signal described above with reference to FIG. 8. The first periodic signal can include participation information, timing references, and clock data that secondary devices 506 use to align and join the session. In some implementations, the primary device 504 can transmit the first periodic signal after receiving a request to establish the session and completing setup of the broadcast isochronous group (BIG) and one or more broadcast isochronous streams (BIS). For example, once the BIG and BIS configuration parameters are generated (e.g., following step 1302), the primary device 504 may transmit periodic advertisements containing PA and BIGInfo fields to communicate the session identifier, broadcast offset, and available slot information to nearby secondary devices 506. In another example, the primary device 504 can transmit first periodic signals through periodic advertising channels every 100 milliseconds during both active and idle operating modes. The first periodic signal may include values for various configuration parameters, such as BIG_offset, BIS_payloadcount, and encryption keys, that allow newly joining devices 506 to derive proper timing alignment and security context for communication with the group.

In some implementations, after transmitting/broadcasting the first periodic signal, various devices may join the device group 502. For example, a device may join the device group automatically (e.g., where the BIG is a public BIG), and/or may join the device group through one or more of the join mechanisms described herein (e.g., through a computer readable medium, such as a URL or QR code, a voice command, a PAST, user inputs to selectable elements on the device, etc.). Devices may join the device group based on or according to the information/configuration/signaling included in the first periodic signal broadcast by the primary device 504.

The method 1300 can include receiving a signal indicating an intent to participate a device group (step 1306). In some implementations, the primary device 504 can receive a join signal/join request/join message transmitted by a secondary device 506 as an indication of intent to join and/or participate in an active broadcast isochronous group. The join signal can be detected after the primary device 504 broadcasts a synchronization signal that advertises participation parameters to nearby/neighboring devices (e.g., devices within the communication range 508 of the primary device 504 and/or any secondary devices 506 which rebroadcast the advertisement/function as relays/daisy-chaining messaging to extend range). The primary device 504 can parse the received join signal to extract fields, such as a device identifier, a hierarchical rank, and authentication data corresponding to an onboarding credential or broadcast code. In some implementations, the primary device 504 can validate the onboarded information against encryption or session parameters maintained in memory before authorizing participation. For example, when the joining device provides a QR code or voiced identifier during onboarding, the primary device 504 can verify that the hashed value of the credential matches the current broadcast code associated with the group session. In another example, the primary device 504 can identify that multiple join signals have been received and can update its membership registry with each new entry, assigning a temporary broadcast isochronous stream number or slot index to every accepted device. The primary device 504 can store timing information and clock offsets in association with each new member and can update the synchronization data included in the next periodic broadcast to reflect the revised group composition.

In some implementations, the primary device 504 may receive the signal indicating intent to participate in the device group, in response to the secondary device 506 detecting voice activity from a user of the secondary device 506. In this regard, the signal may include a request for a slot allocation (e.g., for transmission/broadcasting of audio signals corresponding to the voice activity). The signaling may be received from a secondary device 506 which previously joined the device group (e.g., whether known to the primary device 504 and authenticated through join signaling, or unknown to the primary device 504 where the device group is a public device group).

The method 1300 can include assigning communication resources (step 1308). The primary device 504 can execute a resource assignment operation after validating one or more signals received from participating secondary devices 506 requesting communication resources for transmission of audio signals to the device group. The primary device 504 can determine an allocation of broadcast isochronous stream (BIS) slots and corresponding timing offsets within a broadcast isochronous group (BIG) for communication by the device group 502. In some implementations, the primary device 504 can assign BIS slots according to a static arrangement, such that each secondary device 506 receives a fixed time slot indexed by a unique broadcast isochronous stream number and maintained throughout the session. In another implementation, the primary device 504 can apply a dynamic slot allocation procedure that references voice activity detection data received from participant devices to grant temporary resources only during periods of active audio input. For example, when the primary device 504 receives periodic feedback messages identifying quiet conditions, the primary device 504 may subrate certain BIS slots or deactivate redundant intervals to reduce collision probability and power consumption. In another example, when one of the secondary devices 506 triggers a voice activity event, the primary device 504 can identify an available BIS number, assign the corresponding slot index, and issue an updated synchronization message to all active participants, listing the active transmitter identifiers, assigned stream numbers, and related offset parameters in the updated BIGInfo fields for synchronization of the group.

The method 1300 can include broadcasting a second periodic signal to the device group (step 1310). The second periodic signal may be or include information relating to/identifying the assigned communication resources to devices of the device group 502. In some implementations, the primary device 504 (and/or any secondary device 506 which serve in a backup primary role) may broadcast the second periodic signal to the device group 502. The second periodic signal may be similar to/the same as the base described above with reference to FIG. 8. In this regard, the second periodic signal may be or include control signaling indicating various configuration information relating to the BIG, such as communication resources, assigned primary and backup primary roles, among others.

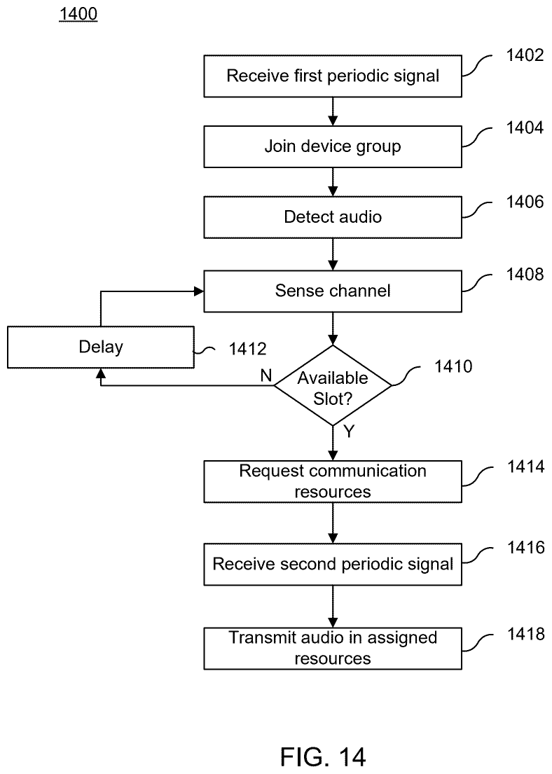

Referring now to FIG. 14, illustrated is a flowchart of a method 1400 for transmitting audio in a group communication session. The method 1400 can be executed, performed, or otherwise carried out by any of the computing systems or wireless devices described herein, such as a secondary device 506 which joins or attempts to join a device group 502. In brief overview of the method 1400, the method 1400 can include receiving a first periodic signal (step 1402), joining a device group (step 1404), detecting audio (step 1406), sensing a channel (step 1408), determining whether an available slot exists (step 1410), delaying transmission (step 1412) when no slot is available, requesting communication resources (step 1414), receiving a second periodic signal (step 1416), and transmitting audio within assigned resources (step 1418).

The method 1400 can include receiving a first periodic signal (step 1402). The secondary device 506 can receive a first periodic signal broadcast by the primary device 504 during formation or continuation of a group communication session (such as the first periodic signal broadcast at step 1304 of FIG. 13). The first periodic signal can include session parameters, such as a session identifier, timing reference, and allocation information, that define participation within the broadcast isochronous group. In some implementations, the secondary device 506 can receive the first periodic signal after power-on, session initiation, or during a periodic channel scan for advertising packets associated with the primary device 504. For example, the secondary device 506 may detect a periodic advertising transmission occurring every 100 milliseconds and parse data fields identifying a broadcast isochronous group offset, a broadcast isochronous stream payload count, and one or more broadcast codes. In another example, the secondary device 506 can receive the first periodic signal through a transceiver tuned to a periodic advertising channel and extract parameters specifying a timing offset. The secondary device 506 can store the extracted parameters in local memory as session data and can align its internal clock to the provided timing information to maintain group synchronization before any audio transmission or control exchange begins.

In some implementations, a secondary device 506 may receive multiple periodic signals (e.g., from a plurality of device groups). For example, where a secondary device 506 is located in a populated area in which multiple groups are active, the secondary device 506 may receive periodic signals from primary devices 504 for each of the device groups which are in wireless range of the secondary device 506. The secondary device 506 may select which of the device groups to join. For example, the secondary device 506 may display, render, or otherwise provide a device group identifier (e.g., group name) to the user, for each device group. The secondary device 506 may receive a selection of which device group to initiate a join procedure, based on a user input to the secondary device 506. As another example, where the secondary device 506 receives multiple first periodic broadcasts, one of which is a from a primary device 504 which has a stored association with the secondary device 506 (e.g., through previously participating in a device group with the primary device 504, through the primary device 504 being a contact in a directory of the secondary device 506, etc.), the secondary device 506 may automatically initiate a join procedure with the known primary device 504.

The method 1400 can include joining a device group (step 1404). The joining operation can be performed by the secondary device 506 to announce participation in the broadcast isochronous group formed by the primary device 504. The secondary device 506 can transmit join signaling (e.g., similar to the signaling received at step 1306 of FIG. 13) through a broadcast transmission that identifies the secondary device 506 and indicates intent to participate in synchronized communication. In some implementations, the secondary device 506 can generate a join signaling containing a device identifier, rank, parent identifier, and encryption credentials of the secondary device 506, and transmit the command after receiving a valid synchronization packet and verifying the broadcast code provided by the primary device 504. For example, the secondary device 506 can transmit a join signal/message at the next anchor broadcast isochronous stream (BIS) point following reception of an advertisement signal or periodic advertising channel frame transmitted by the primary device 504. The transmitted join packet can include the broadcast identifier (BID), session identifier (SID), parent identifier (pID), and the cryptographic credentials of the secondary device 506, which the primary device 504 may acknowledge in an updated synchronization signal to complete admission of the secondary device 506 into the broadcast isochronous group. In another example, the secondary device 506 can join the device group 502 without any dedicated join signaling which notifies the primary device 504 of its presence for inclusion in the group. In this regard, and in certain implementations (such as public device groups 502), a secondary device 506 may join a device group 502 by listening in on the channels identified in the first periodic signal corresponding to the device 502. As such, and in certain public device groups 502, the primary device 504 (and other members of the device group) may not be aware of the number and composition of device group members.

The method 1400 can include detecting audio (step 1406). The secondary device 506 can execute an audio detection process to identify the presence of speech input from an on-device sensor or a microphone coupled to the device 506. In some implementations, the on-device sensor may be a microphone, and the presence of speech input can be indicated through speaking a keyword or phrase. The secondary device 506 can operate internal digital signal processing (DSP) routines to evaluate segments of captured sound and produce an event trigger when the signal energy, spectral pattern, or feature coefficients satisfies a predetermined set of thresholds that correspond to voice activity. In some implementations, the secondary device 506 can maintain a running comparison of successive audio samples against stored baseline noise levels, to determine when a transition from silence to speech occurs. For example, upon detecting that the measured acoustic energy satisfies the predefined threshold for a defined number of consecutive samples, the secondary device 506 can generate/apply a voice activation (VOX) flag that causes the device 506 to initiate a slot allocation request for audio transmission. The secondary device 506 can store detection state variables, including peak-to-average energy ratios and filter coefficients, in local memory to maintain consistency across consecutive detection cycles. In some implementations, the on-device sensor may be or include a button or selectable element, and the presence of speech input can be indicated through selection of the selectable element (e.g., push-to-talk). Upon confirming voice activity (e.g., through general speech, through speaking the keyword or phrase, and/or by initiating a push-to-talk), the secondary device 506 can transmit a control message indicating its intent to initiate broadcasting within an available broadcast isochronous stream (BIS) slot, thereby transitioning from an idle to an active audio transmission state within the group communication session.

The method 1400 can include sensing a channel (step 1408), to determine an availability of a slot (step 1410). In some implementations, the secondary device 506 can initiate a channel sensing operation to determine whether any broadcast isochronous stream (BIS) slot is available for use within the device group 502. The secondary device 506 can monitor radio activity across anchor intervals to identify transmission patterns and/or to detect identifiers of active transmitting devices. In some implementations, the secondary device 506 can sense channels based on second periodic signaling from the primary device 504 indicating assigned communication resources to the device group 502. For example, the secondary device 506 can identify whether any channels are available, based on one or more of the channels/slots in the second periodic signaling from the primary device 504 being unreserved/unallocated/available for use.

Where, at step 1410, the secondary device 506 determines that a slot is not available, the method 1400 can proceed to step 1412. Where, at step 1410, the secondary device 506 determines that a slot is available, the method 1400 can proceed to step 1414.

The method 1400 can include delaying transmission (step 1412). The secondary device 506 can defer its audio transmission attempt by applying a randomized waiting interval after determining that no broadcast isochronous stream (BIS) slot is available for use. In some implementations, the secondary device 506 can generate a pseudo-random backoff counter that specifies a number of anchor epochs to wait before performing a new channel-sensing cycle. For example, the secondary device 506 can compute a random integer within a defined backoff range and store the counter as a temporary variable controlling the length of the delay. During this period, the secondary device 506 can suspend any voice-activated (VOX) transmission triggers and monitor control messages from the primary device 504 to detect changes in slot assignments or the appearance of newly available BIS windows. When a random backoff interval concludes, the secondary device 506 can reenter the sensing process to reassess channel status and, if an available slot is identified, proceed to step 1414.

The method 1400 can include requesting communication resources (step 1414). The secondary device 506 can transmit a resource request message to the primary device 504 to obtain an available broadcast isochronous stream (BIS) slot for audio transmission. The secondary device 506 can generate the resource request message after determining the presence of an unoccupied slot during channel sensing and detecting that voice activity has been triggered on the onboard sensor. In some implementations, the resource request message can be transmitted as a control protocol data unit (PDU) embedded within a BIS frame, and can include specific fields such as a device identifier, a current voice activity status, and a desired bitrate for the forthcoming transmission. For example, the secondary device 506 can generate the control PDU with an opcode identifying a “start” command to indicate audio transmission intent and attach the corresponding control data payload containing the device identifier and timing offset information. In another example, the secondary device 506 can issue the resource request within the next anchor interval following the channel sensing cycle, to align timing of the secondary device 506 with the primary device 504 and reduce the chance of slot contention. The primary device 504 can subsequently interpret the received control packet as a request for slot allocation and respond with an updated second periodic signal that identifies the assigned BIS slot and timing parameters for subsequent transmissions by the secondary device 506.

The method 1400 can include receiving a second periodic signal (step 1416). The secondary device 506 can receive the second periodic synchronization signal transmitted/broadcast by the primary device 504 after the primary device 504 processes a new slot allocation request. In this regard, the second periodic signal may be updated relative to previous second periodic signals (e.g., reflecting newly assigned communication resources). The second periodic signal may be similar to the second periodic signal broadcast at step 1310 of FIG. 13. The second periodic signal can include revised slot mapping and timing information indicating the assignment of a communication slot to the secondary device 506. In some implementations, the second periodic signal can carry data fields, such as a device identifier, an assigned broadcast isochronous stream (BIS) number, a current BIS payload count, and updated encryption key references within the BIGInfo structure. For example, after the primary device 504 validates a slot allocation request triggered by a voice activity event on the secondary device 504, the primary device 504 can issue a subsequent second periodic signal reflecting the granted slot and incorporating corresponding BIG_offset and BISpayloadcount values. The secondary device 506 can apply the received timing values and offset parameters, such that subsequent audio frames are broadcast in proper temporal alignment with the group schedule. Each transmit interval can be derived locally from the BIG_offset data, configuring the secondary device 506 to synchronize the transmit clock and maintain deterministic time division operation within the broadcast isochronous group.

The method 1400 can include transmitting audio in assigned resources (step 1418). The secondary device 506 can perform the broadcast transmission after receiving and applying the second periodic signal from the primary device 504. The secondary device 506 can transmit audio frames encoded in various formats, such as LC3 format, during assigned broadcast isochronous stream (BIS) intervals, while maintaining temporal alignment with the clock reference indicated in the first/second periodic signals. In some implementations, the secondary device 506 may continue to operate in broadcast mode without establishing a dedicated connection, thereby transmitting audio and control information within the same broadcast structure. For example, the secondary device 506 can transmit consecutive encoded audio packets every 10 milliseconds during an active talk phase while embedding control protocol data units (PDUs) within selected broadcast frames to communicate slot utilization, timing offsets, and/or status values. In another example, the secondary device 506 can interleave audio and feedback packets within the same BIS allocation so that other members of the device group 502 can confirm slot activity and maintain clock synchronization continuity. Each audio broadcast event from the secondary device 506 can therefore represent both an information exchange and a timing update that contributes to maintenance of session stability and alignment across multiple synchronized devices operating within the group communication environment.

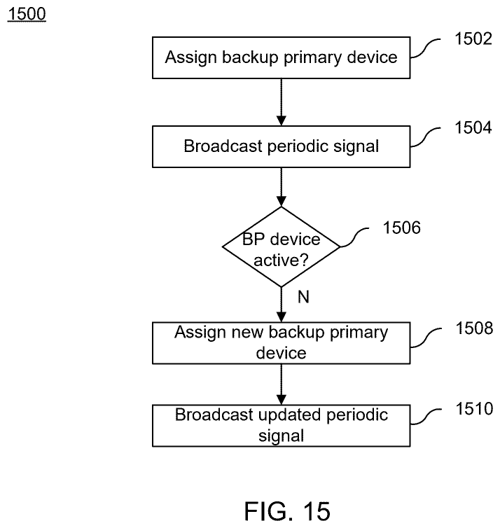

Referring now to FIG. 15, illustrated is a method 1500 of configuring a backup primary device within a decentralized group audio communication session. The method 1500 can be executed, performed, or otherwise carried out by any of the computing systems or wireless devices described herein, such as a primary device 504. In brief overview of the method 1500, the method 1500 can include assigning a backup primary device (step 1502), broadcasting a periodic signal (step 1504), determining whether a backup primary device is active (step 1506), assigning a new backup primary device (step 1508), and broadcasting an updated periodic signal (step 1510).

The method 1500 can include assigning a backup primary device (step 1502). The primary device 504 can assign a backup primary device to maintain clock continuity within the group communication session. The primary device 504 can select a secondary device 506 to act as the backup clock reference based on link proximity, received signal quality, or processing capability parameters recorded in the group synchronization table. In some implementations, the primary device 504 can designate the backup primary as the first secondary device 506 that successfully joins the session. For example, when the primary device 504 detects that a secondary device 506 satisfies initial timing alignment thresholds, the primary device 504 can embed an assignment indicator within a control broadcast (e.g., a periodic signal, as described below) that includes the device identifier, rank, and timing parameters identifying the selected device as the backup primary. In some implementations, the control broadcast can appear within a broadcast isochronous group (BIG) information field, which may configure all other devices in the device group 502 to decode the updated hierarchy and adjust synchronization accordingly. The assignment procedure can be performed either at session initialization or in response to detecting departure of a previously active backup primary, thereby preserving deterministic clock propagation and uninterrupted synchronization across the device group.

The method 1500 can include broadcasting a periodic signal (step 1504). The periodic signal may be the same as/similar to the second periodic signal described above with reference to FIG. 13 and FIG. 14. The primary device 504 can broadcast a periodic signal that distributes updated participation parameters and timing data to every secondary device 506 within the device group 502. In some implementations, the primary device 504 (and/or the designated secondary device 506) can broadcast the periodic signal periodically throughout the group communication session and/or immediately following any change in the clock hierarchy to maintain alignment between the primary device 504 and the designated backup primary device. For example, once the primary device 504 assigns a backup primary device, the primary device 504 can transmit updated periodic signaling frames at approximately 100 millisecond intervals through periodic sequences associated with broadcast isochronous streams (BIS). The periodic signaling frame can include clock trim coefficients, offset values, device identifiers, and hierarchy indicators encoded within broadcast isochronous group (BIG) information fields.

The method 1500 can include determining whether a backup primary device is active (step 1506). The primary device 504 can determine whether the backup primary device 506 remains active by monitoring responses embedded in control protocol data units transmitted during periodic broadcast intervals. After each synchronization interval, the primary device 504 can evaluate confirmation messages or status packets received from the backup primary device 506 to verify that timing alignment information and clock-trim coefficients remain within predetermined drift tolerances. In some implementations, the primary device 504 can perform this verification every 100 milliseconds following a periodic signal broadcast and compare timestamp fields or sequence counters returned by the backup primary device 506 against a stored reference value to confirm continued temporal coherence. For example, when the primary device 504 transmits a periodic broadcast frame containing updated timing parameters, the primary device 504 can wait for a corresponding confirmation packet from the backup primary device 506 that echoes a payload counter or offset value derived from the same epoch. The primary device 504 may also determine/detect/measure/identify deviations in timestamp intervals between expected acknowledgment packets and reference timing data, to classify the backup primary device 506 as active, delayed, or unresponsive. In some implementations, the primary device 504 may detect or identify a loss event when two or more consecutive confirmation intervals exceed a specified timeout duration, and/or when received signal metadata indicate that the backup primary device 506 failed to decode prior synchronization transmissions.

The method 1500 can include assigning a new backup primary device (step 1508). The primary device 504 can perform a reassignment operation to select a new backup primary device after detecting inactivity or loss of acknowledgment from the currently assigned backup (e.g., at step 1506). In some implementations, the primary device 504 can evaluate transmission stability parameters, such as received signal strength indicator (RSSI), packet reception rate, or timing drift of remaining secondary devices 506, and select the device 506 which has the most stable transmission stability parameters to assume the new backup primary role. For example, when a previously assigned backup primary device 506 moves out of range or powers off, the primary device 504 can identify a next available secondary device 506(1) that maintains rank proximity to the primary clock source and exhibits favorable signal-to-noise characteristics, and assign that device as the new backup primary device. The primary device 504 can embed refreshed role identifiers and updated clock propagation references in the next synchronization broadcast to inform all members of the revised hierarchy.

The method 1500 can include broadcasting an updated periodic signal (step 1510). The primary device 504 can broadcast an updated periodic signal after assigning a new backup primary device. Step 1510 may be similar to step 1504, but the updated periodic signal (e.g., the updated second periodic signal broadcast by the primary device 504) may identify the new backup primary device in replacement of the previous backup primary device.

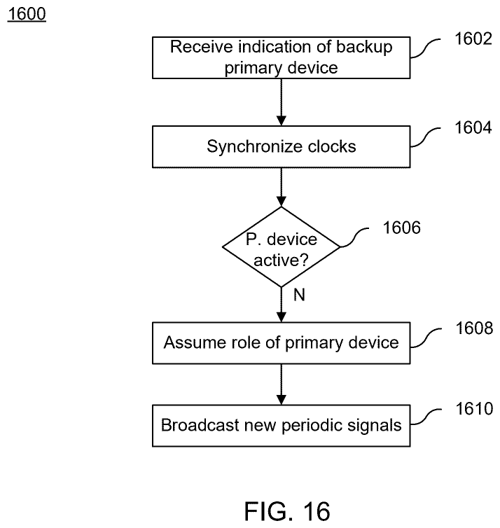

Referring now to FIG. 16, illustrated is a method 1600 for role transitioning from a backup primary device to a primary device. The method 1600 can be executed, performed, or otherwise carried out by any of the computing systems or wireless devices described herein, such as a secondary device 506 in a back-up primary device role (or, more generally, a secondary device 506). In brief overview of the method 1600, the method 1600 can include receiving an indication of backup primary device (step 1602), synchronizing clocks (step 1604), detecting whether a primary device is active (step 1606), assuming the role of a primary device (step 1608), and broadcasting an updated synchronization signal (step 1610).

The method 1600 can include receiving an indication of backup primary device (step 1602). The secondary device 506 can receive, via a wireless transceiver, an indication identifying it as a backup primary device during an active group communication session. The indication can be transmitted by the primary device 504 within an updated broadcast signal or as a discrete control protocol data unit (PDU) superimposed on a broadcast isochronous stream. In some implementations, the secondary device 506 can receive the indication during session initialization when the primary device 504 first establishes the clock hierarchy, or after a subsequent reassignment event triggered by mobility or timing loss of another participant. For example, when the primary device 504 identifies that the secondary device 506 meets rank and link-quality thresholds within the hierarchy table, the primary device 504 can embed a role-designation field in a BIGInfo update that assigns the secondary device 506 as the backup clock reference. Upon reception, the secondary device 506 can parse the control data to confirm the broadcast isochronous group identifier and store a corresponding role flag in local memory. In some implementations, the secondary device 506 may assume the role as backup primary device, responsive to determining that no other device is acting as a backup primary device. For example, the secondary device 506 may identify (e.g., in the second periodic signal) a lack of an identified backup primary device in the device group. Upon identifying the lack of an identified backup primary device, the secondary device 506 may automatically assume a role as backup primary device. Upon assuming the role of backup primary device (e.g., by way of positive indication by the primary device 504 and/or by automatic assumption of the role triggered by the secondary device 506, the secondary device 506 can then prepare an internal oscillator and timing controller to align with the broadcast cadence of the primary device 504. In this regard, through alignment and synchronization, the secondary device 506 can assume the primary role if the primary clock reference becomes unavailable.

The method 1600 can include synchronizing clocks (step 1604). The secondary device 506 can perform a clock synchronization operation by referencing timing data transmitted by the primary device 504 to facilitate continuity of the broadcast isochronous group. The secondary device 506 can receive periodic clock information embedded in synchronization broadcasts and apply offset corrections to internal oscillator counters to align phase and timing accuracy with the primary clock. In some implementations, the secondary device 506 can perform the synchronization procedure upon receiving an indication designating it as the backup primary device, or periodically during each synchronization interval. For example, the secondary device 506 can update its internal time base every 100 milliseconds after receiving each periodic advertisement from the primary device 504, using differential timestamps and clock trim coefficients contained within the control portion of the received synchronization frame. In some implementations, the secondary device 506 can apply mathematical drift correction values to hardware clock oscillators through firmware algorithms that calculate correction deltas relative to the primary reference to maintain drift-free operation. For example, the secondary device 506 can compute a phase adjustment factor derived from the difference in successive payload counter timestamps and apply the correction to its internal counter to sustain deterministic alignment across all intervals of the broadcast isochronous group.

The method 1600 can include detecting whether a primary device is active (step 1606). The secondary device 506 can monitor active broadcast channels to determine whether the primary device 504 remains active in the group communication session. The secondary device 506 can reference first/second periodic signals broadcast by the primary device 504, to detect any lapse in reception thereof (e.g., over a defined timeout period or missed packet threshold). In some implementations, the secondary device 506 can analyze packet timing data, payload counters, and associated timestamps received from the primary device 504 to measure deviations in the expected inter-message intervals. For example, after detecting an absence of two or more consecutive second periodic signals, the secondary device 506 can retrieve, determine, or identify whether the primary device 504 continues to broadcast the first periodic signals (e.g., periodic advertising (PA) or auxiliary advertising (AUX_ADV) packets). In another example, the secondary device 506 can compare the most recent broadcast isochronous stream payload count and synchronization timeout parameters against an internal clock reference to verify reachability of the primary device 504. When the secondary device 506 detects deviations satisfying (e.g., meeting or exceeding) a defined timing threshold, the secondary device 506 can classify the event as a primary-absence condition and prepare to assume control of synchronization broadcast operations under its backup primary role.

The method 1600 can include assuming the role of primary device (step 1608). The secondary device 506 can assume operation or role as a primary device upon confirming that a previously active primary device 504 is not transmitting periodic signals within a predetermined lapse period. The secondary device 506 can promote its internal clock to serve as a new primary reference and begin generating broadcast timing data that preserves the prior broadcast isochronous group structure. In this regard, the secondary device 506 may preserve the same/similar periodic signals and configurations as those provided by the primary device 504, thereby maintaining consistency during the transition period from the previously active primary device 504 to the secondary device 506 assuming the operation or role as primary device. In some implementations, the secondary device 506 can initiate a scheduling sequence in which new timing offsets, slot indices, and broadcast isochronous stream payload counters are produced based on the most recently valid parameters received before primary loss. For example, after a lapse of approximately 300 milliseconds without detecting a valid synchronization broadcast, the secondary device 506 can assert a local flag designating itself as the current primary, activate its transceiver in transmit mode, and broadcast updated periodic signals/frames including refreshed timing and session identifiers. The secondary device 506 can continue to transmit using a free-running clock source while gradually reducing any residual trim offset to maintain drift tolerance with prior clock specifications. In some implementations, the newly promoted secondary device 506 can direct inclusion of its unique device ID and hierarchical rank values in the next broadcast header to signal its leadership role and initiate assignment of a new backup primary device within the subsequent synchronization cycle, maintaining redundancy and continuity across the group communication session.

The method 1600 can include broadcasting new periodic signals (step 1610). The secondary device 506 can broadcast new periodic signals to all other devices within the device group 502 after assuming the role of the primary device 504. The secondary device 506 can generate and transmit periodic similar to those broadcast by the primary device (e.g., at step 1304 and 1310 of FIG. 13). In this regard, the periodic signals broadcast at step 1610 can include updated broadcast isochronous group (BIG) information defining the current status of the secondary device 506 as the primary device, a refreshed timing hierarchy, and resource allocation data for each participating device. In some implementations, the secondary device 506 can include a payload counter, timestamp, and epoch identifier within the periodic signals to establish a new master reference period that replaces the previously active primary clock. For example, the periodic signals can embed revised BIG_offset and BIS_payloadcount values that reset time alignment across all devices while maintaining association with the existing broadcast session identifiers to prevent session interruption. The secondary device 506 can further insert modified role identifiers and slot assignment data into the periodic signals (e.g., the second periodic signal described herein) to indicate any hierarchical or allocation changes resulting from the promotion event. In some implementations, the broadcast can occur following primary assumption and/or during the next anchor broadcast interval, allowing all secondary devices 506(1)-506(N) to recalibrate internal clocks and continue audio streaming without reinitializing the broadcast isochronous group. For example, the secondary device 506 can transmit the synchronization update with revised encryption key references and broadcast identifiers, to configure/cause continuity of the session under the newly established hierarchy while maintaining consistent time-division scheduling among the remaining devices in the device group 502.

Having now described some illustrative implementations, it is apparent that the foregoing is illustrative and not limiting, having been presented by way of example. In particular, although many of the examples presented herein involve specific combinations of method acts or system elements, those acts and those elements can be combined in other ways to accomplish the same objectives. Acts, elements and features discussed in connection with one implementation are not intended to be excluded from a similar role in other implementations or implementations.

The hardware and data processing components used to implement the various processes, operations, illustrative logics, logical blocks, modules and circuits described in connection with the embodiments disclosed herein may be implemented or performed with a general purpose single-or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function. The memory (e.g., memory, memory unit, storage device, etc.) may include one or more devices (e.g., RAM, ROM, Flash memory, hard disk storage, etc.) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an exemplary embodiment, the memory is communicably connected to the processor via a processing circuit and includes computer code for executing (e.g., by the processing circuit and/or the processor) the one or more processes described herein.

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

The phraseology and terminology used herein is for the purpose of description and should not be regarded as limiting. The use of “including” “comprising” “having” “containing” “involving” “characterized by” “characterized in that” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any references to implementations or elements or acts of the systems and methods herein referred to in the singular can also embrace implementations including a plurality of these elements, and any references in plural to any implementation or element or act herein can also embrace implementations including only a single element. References in the singular or plural form are not intended to limit the presently disclosed systems or methods, their components, acts, or elements to single or plural configurations. References to any act or element being based on any information, act or element can include implementations where the act or element is based at least in part on any information, act, or element.

Any implementation disclosed herein can be combined with any other implementation or embodiment, and references to “an implementation,” “some implementations,” “one implementation” or the like are not necessarily mutually exclusive and are intended to indicate that a particular feature, structure, or characteristic described in connection with the implementation can be included in at least one implementation or embodiment. Such terms as used herein are not necessarily all referring to the same implementation. Any implementation can be combined with any other implementation, inclusively or exclusively, in any manner consistent with the aspects and implementations disclosed herein.

Where technical features in the drawings, detailed description or any claim are followed by reference signs, the reference signs have been included to increase the intelligibility of the drawings, detailed description, and claims. Accordingly, neither the reference signs nor their absence have any limiting effect on the scope of any claim elements.

Systems and methods described herein may be embodied in other specific forms without departing from the characteristics thereof. References to “approximately,” “about” “substantially” or other terms of degree include variations of +/−10% from the given measurement, unit, or range unless explicitly indicated otherwise. Coupled elements can be electrically, mechanically, or physically coupled with one another directly or with intervening elements. Scope of the systems and methods described herein is thus indicated by the appended claims, rather than the foregoing description, and changes that come within the meaning and range of equivalency of the claims are embraced therein.

The term “coupled” and variations thereof includes the joining of two members directly or indirectly to one another. Such joining may be stationary (e.g., permanent or fixed) or moveable (e.g., removable or releasable). Such joining may be achieved with the two members coupled directly with or to each other, with the two members coupled with each other using a separate intervening member and any additional intermediate members coupled with one another, or with the two members coupled with each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References to “or” can be construed as inclusive so that any terms described using “or” can indicate any of a single, more than one, and all of the described terms. A reference to “at least one of ‘A’ and ‘B’” can include only ‘A’, only ‘B’, as well as both ‘A’ and ‘B’. Such references used in conjunction with “comprising” or other open terminology can include additional items.

Modifications of described elements and acts such as variations in sizes, dimensions, structures, shapes and proportions of the various elements, values of parameters, mounting arrangements, use of materials, colors, orientations can occur without materially departing from the teachings and advantages of the subject matter disclosed herein. For example, elements shown as integrally formed can be constructed of multiple parts or elements, the position of elements can be reversed or otherwise varied, and the nature or number of discrete elements or positions can be altered or varied. Other substitutions, modifications, changes and omissions can also be made in the design, operating conditions and arrangement of the disclosed elements and operations without departing from the scope of the present disclosure.

References herein to the positions of elements (e.g., “top,” “bottom,” “above,” “below”) are merely used to describe the orientation of various elements in the FIGURES. The orientation of various elements may differ according to other exemplary embodiments, and that such variations are intended to be encompassed by the present disclosure.

What is claimed is:

1. A secondary device comprising:
one or more processors configured to:
receive, via a wireless transceiver, a first periodic signal broadcast from a primary device, the first periodic signal including information for participation in a group communication session;
detect a signal from an on-device sensor indicative of speech input at the secondary device;
transmit, via the wireless transceiver, a slot allocation request to the primary device in response to detecting the signal indicative of speech input;
receive, via the wireless transceiver, a second periodic signal broadcast from the primary device, the second periodic signal assigning a communication slot to the secondary device for broadcasting information to the device group; and
broadcast, via the wireless transceiver and during the assigned communication slot, audio signals representative of speech captured at the secondary device, for receipt by other devices within the device group.

2. The secondary device of claim 1, wherein the request includes device identification information and authentication information.

3. The secondary device of claim 1, wherein the one or more processors are configured to:
receive, via the wireless transceiver, an indication that the secondary device is designated as a backup primary device for the group communication session.

4. The secondary device of claim 3, wherein the indication is received in the second periodic signal.

5. The secondary device of claim 3, wherein the one or more processors are further configured to:
receive, via the wireless transceiver, from the primary device, clock information for synchronization between the primary device and the backup primary device; and
transmit, via the wireless transceiver, a confirmation message to the primary device.

6. The secondary device of claim 5, wherein the one or more processors are configured to synchronize one or more clocks of the secondary device according to the clock information received from the primary device.

7. The secondary device of claim 3, wherein the one or more processors are configured to:
determine, based on a lapse in receipt of periodic signals or other status information from the primary device, that the primary device is offline or unavailable; and
assume the role of primary device for the device group in response to determining that the primary device is offline or unavailable.

8. The secondary device of claim 7, wherein the one or more processors are configured to:
broadcast, via the wireless transceiver and responsive to assuming the role of the primary device, a new first periodic signal and a new second periodic signal to the device group, the new second periodic signal indicating that the secondary device is now the primary device.

9. The secondary device of claim 8, wherein the one or more processors are configured to:
assign communication resources to respective members of the device group, the communication resources including one or more slots for broadcasting of information to the device group, and wherein the assigned communication resources is indicated in the new second periodic signal.

10. The secondary device of claim 1, wherein the signal and the slot allocation request correspond to a first time instance, and wherein the one or more processors are further configured to:
detect, at a second time instance, a second signal from an on-device sensor indicative of subsequent speech input at the secondary device;
determine, based on a most recent second periodic signal from the primary device, an allocation of each of a maximum number of communication resource to a respective device of the device group; and
forego transmission of a slot allocation request to the primary device, based on a lack of availability of communication resources.

11. A method, comprising:
receiving, by one or more processors via a wireless transceiver of a secondary device, a first periodic signal broadcast from a primary device, the first periodic signal including information for participation in a group communication session;
detecting, by the one or more processors, a signal from an on-device sensor indicative of speech input at the secondary device;
transmitting, by the one or more processors and via the wireless transceiver, a slot allocation request to the primary device in response to detecting the signal indicative of speech input;
receiving, by the one or more processors and via the wireless transceiver, a second periodic signal broadcast from the primary device, the second periodic signal assigning a communication slot to the secondary device for broadcasting information to the device group; and
broadcasting, by the one or more processors, via the wireless transceiver and during the assigned communication slot, audio signals representative of speech captured at the secondary device, for receipt by other devices within the device group.

12. The method of claim 11, further comprising:
receiving, by the one or more processors and via the wireless transceiver, an indication that the secondary device is designated as a backup primary device for the group communication session.

13. The method of claim 12, wherein the indication is received in the second periodic signal.

14. The method of claim 13, further comprising:
receiving, by the one or more processors and via the wireless transceiver, from the primary device, clock information for synchronization between the primary device and the backup primary device; and
transmitting, by the one or more processors via the wireless transceiver, a confirmation message to the primary device.

15. The method of claim 14, further comprising synchronizing, by the one or more processors, one or more clocks of the secondary device according to the clock information received from the primary device.

16. The method of claim 12, further comprising:
determining, by the one or more processors, based on a lapse in receipt of periodic signals or other status information from the primary device, that the primary device is offline or unavailable; and
assuming, by the one or more processors, the role of primary device for the device group in response to determining that the primary device is offline or unavailable.

17. The method of claim 16, further comprising:
broadcasting, by the one or more processors, via the wireless transceiver and responsive to assuming the role of the primary device, a new first periodic signal and a new second periodic signal to the device group, the new second periodic signal indicating that the secondary device is now the primary device.

18. The method of claim 17, further comprising:
assigning, by the one or more processors, communication resources to respective members of the device group, the communication resources including one or more slots for broadcasting of information to the device group, and wherein the assigned communication resources is indicated in the new second periodic signal.

19. The method of claim 11, wherein the signal and the slot allocation request correspond to a first time instance, the method further comprising:
detecting, by the one or more processors, at a second time instance, a second signal from an on-device sensor indicative of subsequent speech input at the secondary device;
determining, by the one or more processors, based on a most recent second periodic signal from the primary device, an allocation of each of a maximum number of communication resource to a respective device of the device group; and
forego transmission of a slot allocation request to the primary device, based on a lack of availability of communication resources.

20. A non-transitory computer readable medium storing instructions that, when executed by one or more processors of a secondary, cause the one or more processors to:
receive, via a wireless transceiver, a first periodic signal broadcast from a primary device, the first periodic signal including information for participation in a group communication session;
detect a signal from an on-device sensor indicative of speech input at the secondary device;
transmit, via the wireless transceiver, a slot allocation request to the primary device in response to detecting the signal indicative of speech input;
receive, via the wireless transceiver, a second periodic signal broadcast by the primary device, the second periodic signal assigning a communication slot to the secondary device for broadcasting information to the device group; and
broadcast, via the wireless transceiver and during the assigned communication slot, audio signals representative of speech captured at the secondary device, for receipt by other devices within the device group.
